(19) United States
(12) Patent Application Publication
(10) Pub. No.: US 2016/0021177 A1
(43) Pub. Date: Jan. 21, 2016

(54) RECORDING MEDIUM STORING DISTRIBUTION PROCESSING PROGRAM, DISTRIBUTION PROCESSING MANAGEMENT APPARATUS AND DISTRIBUTION PROCESSING METHOD

(71) Applicant: FUJITSU LIMITED, Kawasaki-shi (JP)

(72) Inventors: Kenji KOBAYASHI, Kawasaki (JP); Yusuke KOYANAGI, Kawasaki (JP); Tateki Imaoka, Chigasaki (JP); Masazumi Matsubara, Machida (JP); Yoshinori Sakamoto, Kawasaki (JP)

(21) Appl. No.: 14/735,218

(22) Filed: Jun. 10, 2015

(30) Foreign Application Priority Data
Jul. 16, 2014 (JP) 2014-146170

(51) Int. Cl. H04L 29/08; H04L 12/24

(52) U.S. Cl. CPC H04L 67/1008; H04L 41/5054

(57) ABSTRACT

A computer obtains a load value relating to a detection process from each of a plurality of server devices that execute, in units of pieces of identification information, the detection process of a pattern of data distributed by a transfer device that distributes input data in accordance with identification information. When a load value obtained from a first server device among the plurality of server devices exceeds a specified allowable range, the computer executes a process for moving, in units of combinations, a combination of identification information and one pattern corresponding to the identification information from the first server device to a second server device among the plurality of server devices depending on whether load values of the first server device and the second server device respectively fall within the allowable range.

### CROSS-REFERENCE TO RELATED APPLICATION

This application is based upon and claims the benefit of priority of the prior Japanese Patent Application No. 2014-146170, filed on Jul. 16, 2014, the entire contents of which are incorporated herein by reference.

### FIELD

The invention discussed herein are related to distribution processing.

### BACKGROUND

A real-time detection technique that detects and outputs a specified pattern for each of various external events from a large amount of data that flows in real time is presented. Such a real-time detection technique is used in an information processing system utilized, for example, in fields such as finance, medicine, security and the like.

As one method for storing and processing such a large amount of event data, a distributed Key-Value Store (hereinafter abbreviated to KVS) technique is presented (for example, Non-patent Document 1).
Non-patent Document 1: Giuseppe DeCandia and 8 others, “Dynamo: Amazon's Highly Available Key-value Store” ACM SIGOPS Operating Systems Review—SOSP '07, Volume 41 Issue 6, December 2007 Pages 205-220

### SUMMARY

A distribution processing program according to one aspect of the present invention causes a computer to execute the following process. Namely, the computer obtains a load value relating to a detection process from each of a plurality of server devices that execute, in units of pieces of identification information, a detection process of a pattern of data distributed by a transfer device that distributes input data in accordance with identification information assigned to the input data. When a load value obtained from a first server device among the plurality of server devices exceeds a specified allowable range, the computer executes the following process. Namely, the computer moves, in units of combinations, a combination of identification information and one pattern corresponding to the identification information from the first server device to a second server device among the plurality of server devices depending on whether load values of the first server device and the second server device respectively fall within the allowable range.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a real-time detection system.

FIG. 2 illustrates an example of an input event distribution processing system.

FIG. 3 illustrates an example of a pattern distribution processing system.

FIG. 4 illustrates a distribution processing management apparatus according to an embodiment.

FIG. 5 is an explanatory diagram of a load move control process in this embodiment.

FIG. 6 illustrates an example of an event detection system in this embodiment.

FIG. 7 illustrates examples of a routing table, a load table and an overall load table that are used in the event detection system in this embodiment.

FIG. 8 illustrates a flow for executing methods 1 to 4 depending on whether a monitoring target in this embodiment satisfies a corresponding condition.

FIG. 9 is an explanatory diagram of method 1 in this embodiment.

FIGS. 10A-10C are explanatory diagrams of method 2 in this embodiment.

FIG. 11 is an explanatory diagram of method 3 in this embodiment.

FIG. 12 illustrates a flow of a load move process that uses method 1 and is executed by a move management unit of a management server in this embodiment.

FIG. 13 illustrates a flow of an after-move condition determination process in this embodiment.

FIG. 14 illustrates a flow of a load move process that uses method 2 and is executed by the move management unit of the management server in this embodiment.

FIG. 15 illustrates a flow of a load move process that uses method 3 and is executed by the move management unit of the management server in this embodiment.

FIG. 16 illustrates a flow of a load move process that uses method 4 and is executed by the move management unit of the management server in this embodiment.

FIG. 17 illustrates an example of a configuration block diagram of a hardware environment of a computer that executes a program according to this embodiment.

### DESCRIPTION OF EMBODIMENTS

A technique for distributing a detection process to a plurality of servers and for executing the process in order to quickly detect a plurality of patterns when there are the plurality of patterns to be detected is presented. As such a distribution detection process, it is conceivable to distribute event data to servers, for example, in accordance with a key of input event data, and to distribute the event data for each pattern of the event data.

However, in the above described distributed detection process, a load imposed on any of the servers or a communication with any of the servers may become uneven, and a load distribution of the pattern detection process cannot be performed with a high efficiency.

According to one aspect of the embodiments, a technique for improving the leveling accuracy of a distributed load in a pattern detection distribution process of input data is provided.

The number of patterns increases or decreases depending on the amount of input event data, or the content of a pattern extraction process. For example, in the case of big data, only one server has a limitation since the amount of input event data and the number of patterns are large. Therefore, the distribution process is executed by using a plurality of servers in many cases. In the meantime, it is also important to use servers by a number pursuant to a load in terms of cost.

Accordingly, a distribution processing mechanism that dynamically enables a load distribution in accordance with an increase or a decrease in the amount of input event data or the number of patterns and that maintains a low latency and a high throughput is demanded.

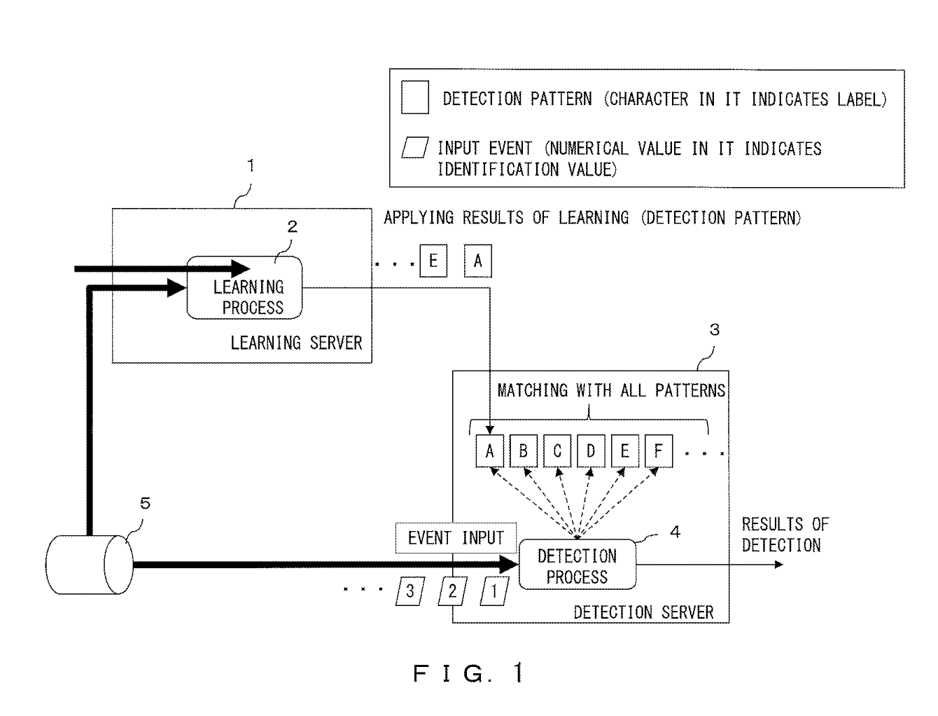

FIG. 1 illustrates an example of a real-time detection system. In the real-time detection system, a learning server 1 detects, with a learning process 2, a pattern of event data that flows in a communication network, and extracts the detected pattern. For the sake of explanation, event data is assumed to be event data of a particular event in FIG. 1. As a result of the learning process, the learning server 1 transmits extracted patterns A, B, C, . . . , to a detection server 3. Here, examples of patterns of data include a pattern of a bit string of packet data, a pattern of a size of a packet, a waveform pattern of a voltage of data when the data is observed in a time series, a pattern of an access behavior to a server, and the like.

To the detection server 3, event data that occurs for each event and flows in a communication network in real time is input via a transfer server 5. Here, to the input event data, unique identification information including, for example, an event type for identifying an event and an identification value assigned to each event indicated by an event type is assigned.

The event data is data of a type of event. The event type indicates, for example, temperature sensor data, power sensor data of a power distribution board, or communication data of a terminal. When event types differ, attributes of event data are also different. When event data is temperature sensor data, an attribute of the event data is, for example, (device ID, temperature). When the event data is communication data, an attribute of the event data is, for example, (a terminal ID, an IP address of a connection destination, and the volume of a communication).

Additionally, the identification value is a particular value of an event indicated by an event type, and is a value of any one attributes decided depending on which attribute is used to execute a process such as summation. For example, when event data is temperature sensor data having an attribute (device ID, temperature) and a temperature average value for one hour is summated for each device ID, an identification value is a device ID.

The detection server 3 performs, with a detection process 4, a matching between the input event data and all patterns provided by the learning server 1.

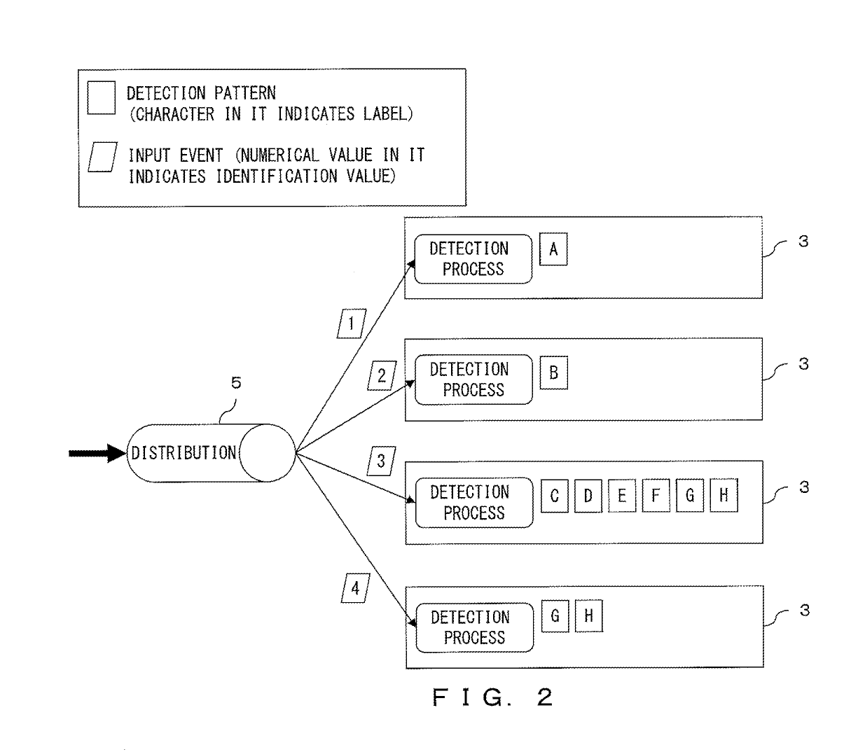

However, when the detection process (matching) between all pieces of the input event data and all the patterns is executed, a network, a central processing unit (CPU), a memory, or the like becomes a bottleneck, leading to a degradation of latency. Accordingly, when the detection process (matching) between all the pieces of the input event data and all the patterns is executed, it is not preferable to use only one detection server. Accordingly, it is conceivable to execute the pattern matching process by using a plurality of detection servers, as illustrated in FIG. 2.

FIG. 2 illustrates an example of an input event distribution processing system. For the sake of explanation, event data is assumed to be that of a particular event in FIG. 2, and an event type is not taken into account. An identification value assigned to event data is defined as a distribution key value. In the input event distribution processing system, each of the detection servers 3 stores a pattern according to a distribution key value. Upon receipt of event data that flows in a communication network, the transfer server 5 distributes the event data to any of the detection servers 3 in accordance with a distribution key value, assigned to the event data, for each event type.

Each of the detection servers 3 performs a pattern matching between data according to a distribution key value of an event that the local detection server is responsible for and a pattern held in advance. Thus, even though the amount of input event data increases, the distribution parallel processing of the pattern matching process is enabled by increasing the number of detection servers.

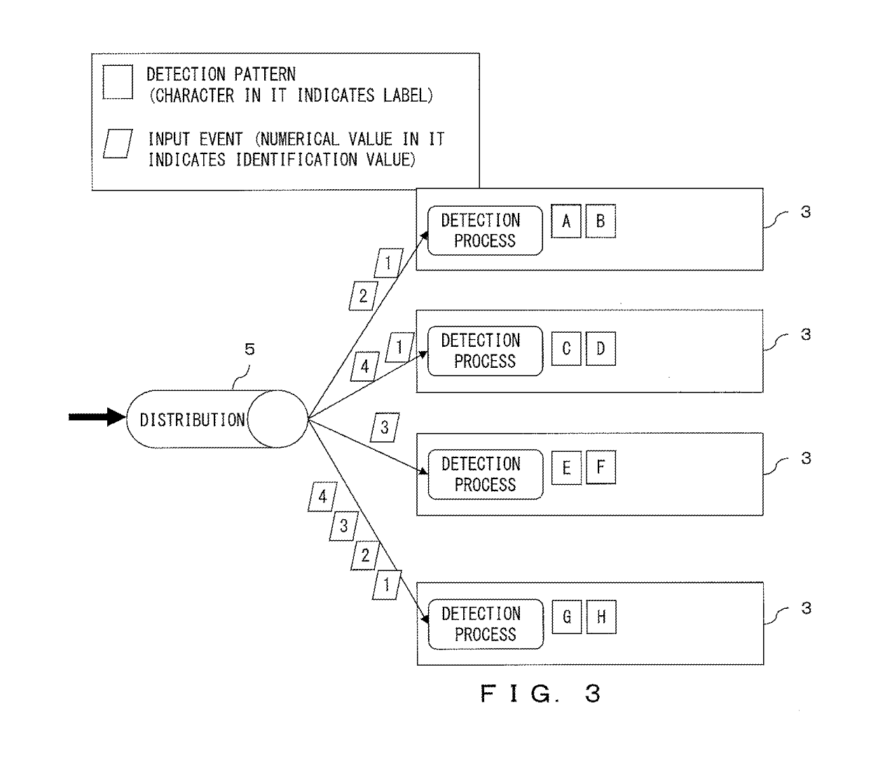

However, when the number of patterns for a distribution key value of an event grows, the amount of pattern matching processing increases. As a result, latency increases. As described above, in the distribution parallel processing using a distribution key value, loads imposed on the detection servers 3 become uneven, so that the loads are hindered from being leveled. In some cases, a detection server can crash. Accordingly, it is conceivable to make the numbers of patterns held respectively by detection servers even, as illustrated in FIG. 3.

FIG. 3 illustrates an example of the pattern distribution processing system. For the sake of explanation, event data is assumed to be that of a particular event in FIG. 3, and an event type is not taken into account. In the pattern distribution processing system, the numbers of patterns held respectively by the detection servers 3 are equalized. As described above, by distributing event data respectively for patterns, the unevenness of the numbers of patterns in FIG. 2 can be handled.

In the pattern distribution processing system, each of the detection servers 3 is responsible for a matching process of event data corresponding to a distribution key value of an event that corresponds to a pattern held by the local server 3. Therefore, depending on a detection server 3, a distribution key value that the local detection server 3 is responsible for becomes plural in some cases. Moreover, since the number of detection servers 3 responsible for the same distribution key value becomes plural, the transfer server 5 multicasts input event data to all the detection servers 3.

Accordingly, there is a possibility that the numbers of distribution key values for particular patterns will become uneven, and also that the traffic of a communication will be increased by multicasting. As described above, the pattern distribution processing system causes a network bottleneck, leading to a possible degradation in scalability.

Therefore, this embodiment refers to a distribution performed while maintaining scalability by leveling loads even though the amount of input event data and the number of patterns dynamically increase or decrease.

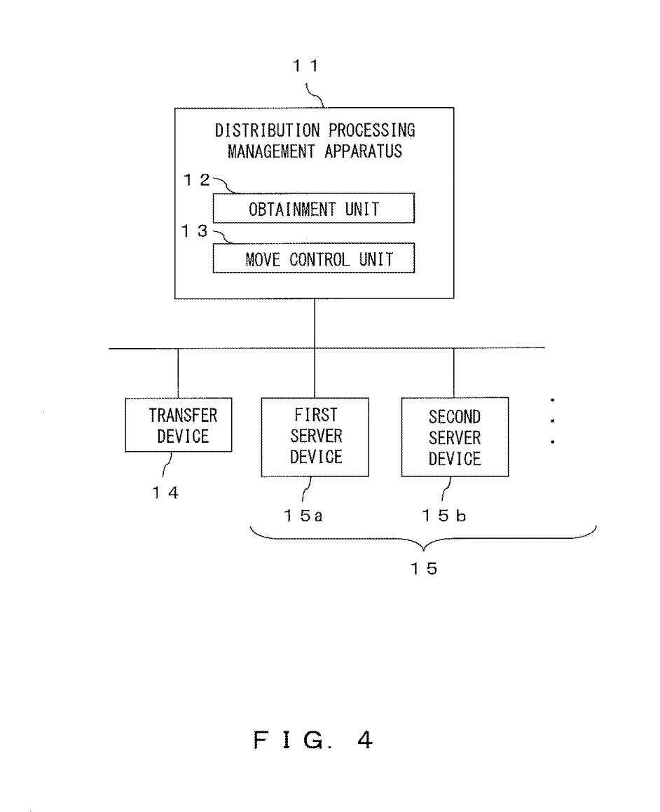

FIG. 4 illustrates a distribution processing management apparatus according to this embodiment. The distribution processing management apparatus 11 includes an obtainment unit 12 and a move control unit 13. As one example of the distribution processing management apparatus 11, a management server 36 is cited.

The obtainment unit 12 obtains a load value of the detection process in units of pieces of identification information from each of a plurality of server devices 15. The plurality of server devices 15 execute a pattern detection process of data distributed by the transfer device 14 for each piece of identification information. The transfer device 14 distributes input data in accordance with identification information assigned to the data. As one example of the plurality of server devices 15, a detection server 41 is cited. As one example of the transfer device 14, a transfer server 33 is cited. As one example of the obtainment unit 12, the move management unit 37 is cited. The identification information may be one unique data entry, or may be made unique by combining a plurality of data entries, such as a combination of an event type and a distribution key value in this embodiment.

The move control unit 13 executes the following process when the load value obtained by a first server device 15a among the plurality of server devices 15 exceeds a specified allowable range. Namely, the move control unit 13 moves a combination of identification information and one pattern corresponding to the identification information from the first server device 15a to a second server device 15b among the plurality of server devices 15 in units of combinations. The combination of the identification information and the one pattern corresponding to the identification information is moved depending on whether load values of the first server device 15a and the second server device 15b are respectively within an allowable range. As one example of the move control unit 13, the move management unit 37 is cited.

With such a configuration, the leveling accuracy of a distributed load can be improved in the pattern detection distribution process for input data.

The move control unit 13 executes the following process when the load value, obtained from the first server device 15a, of the detected load of the first server device 15a exceeds a first allowable range (corresponding to a first condition to be described later). The move control unit 13 moves one or a plurality of combinations from the first server device 15a to the second server device 15b, and determines whether the load values of the detected loads of the first server device 15a and the second server device 15b fall within the first allowable range. When the load values of the detected loads of the first server device 15a and the second server device 15b fall within the first allowable range, the move control unit 13 issues, to the first server device 15a, an instruction to move the one or the plurality of combinations to the second server device 15b.

With such a configuration, a combination of identification information and a pattern can be used as a unit of a move, so that the granularity of the unit of the move can be made precise. As a result, the leveling of a distribution of a load (a detection process cost of each server) can be adjusted more flexibly, whereby the accuracy of leveling can be improved. Moreover, when the load value obtained from the first server device 15a exceeds the allowable range, the leveling of the load is adjusted. As a consequence, the load can be dynamically distributed.

Additionally, the move control unit 13 executes the following process when the load value, obtained from the first server device 15a, of the communication load of the first server device 15a exceeds a second allowable range (corresponding to a second condition to be described later) as the second condition. Namely, the move control unit 13 moves all patterns corresponding to identification information processed by the first server device 15a from the first server device 15a to the second server device 15b, and determines whether the load values of the communication loads of the first server device 15a and the second server device 15b fall within the second allowable range. When the load values of the communication loads of the first server device 15a and the second server device 15b fall within the second allowable range, the move control unit 13 issues, to the first server device 15a, an instruction to move identification information and all the patterns corresponding to the identification information to the second server device 15b.

With such a configuration, the leveling of a distribution of a load (a communication process cost of each server) can be adjusted.

Furthermore, the move control unit 13 executes the following process when a total of load values, respectively obtained from the plurality of server devices 15, of the plurality of server devices 15 exceeds a third allowable range (corresponding to a third condition to be described later). Assume that the first server device 15a executes a detection process having the lightest load on the process. The move control unit 13 moves a pattern to be detected used in the detection process having the lightest load to the second server device 15b, and determines whether the load values of the detected loads of the first server device 15a and the second server device 15b respectively fall within the first allowable range. When the load values of the detected loads of the first server device 15a and the second server device 15b respectively fall within the first allowable range, the move control unit 13 issues, to the second server device 15b, an instruction to move one or a plurality of combinations to the second server device 15b.

With such a configuration, the load imposed on the entire network can be reduced.

The move control unit 13 moves identification information of a pattern without moving the real data of the pattern possessed by the second server device 15b among patterns included in the combination to be moved. In the meantime, the move control unit 13 moves the real data of a pattern, and identification information of the pattern that is not possessed by the second server device among the patterns included in the combination to be moved.

Such a configuration eliminates the need for moving, to a move destination server, the real data of a pattern possessed by the second server device 15b among patterns included in a combination to be moved. In consequence, a communication cost can be reduced.

Additionally, when one or a plurality of combinations are moved to the second server device 15b and the load values of the first server device 15a and the second server device 15b exceed an allowable range, the move control unit 13 makes a notification of adding or deleting a server device 15.

With such a configuration, a load can be distributed while maintaining scalability by dynamically increasing or decreasing the number of servers, when a load imposed on an existing server exceeds an allowable range and the load cannot be leveled.

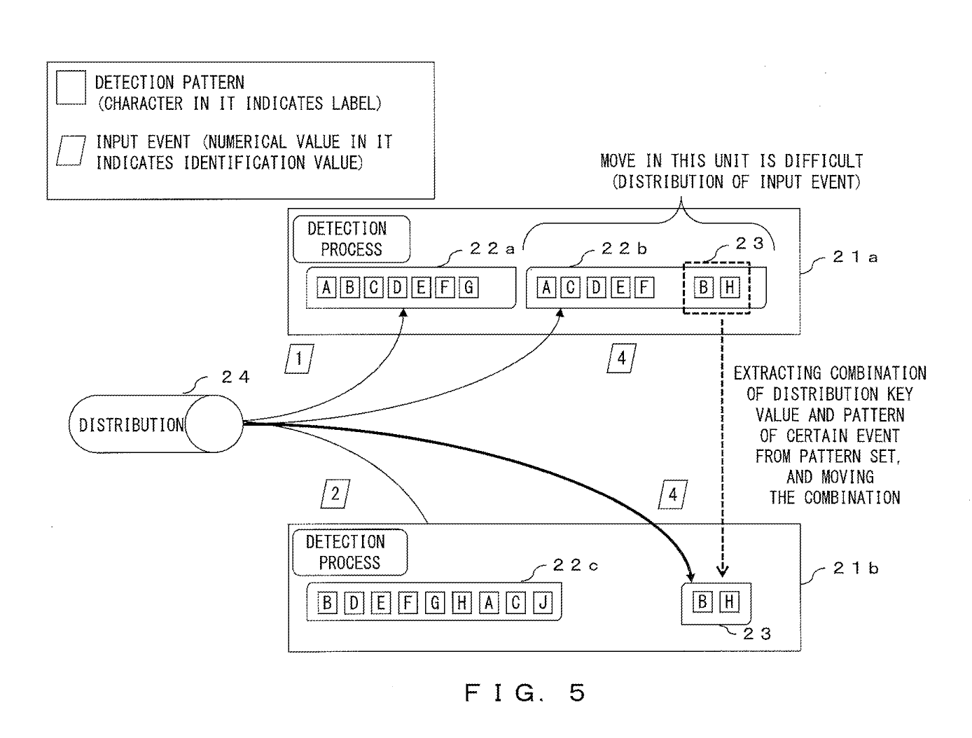

FIG. 5 is an explanatory diagram of a load move control process in this embodiment. For the sake of explanation, event data is assumed to be that of a particular event, and an event type is not taken into account in FIG. 5.

A transfer server 24 unicasts an event to a detection server 21 corresponding to a distribution key value of the event on the basis of the distribution key value assigned, for each event, to event data received in real time.

Each of detection servers 21a, 21b stores a distribution key value that the local server is responsible for, and a pattern set 22 (22a, 22b, 22c) to be detected that corresponds to the distribution key value of the event. Even for an event to which the same distribution key value is assigned, content of a pattern set varies depending on the detection server 21 (21a, 21b). For example, the detection server 21a detects a pattern from event data, to which a distribution key value=1 of the certain event is assigned, by using patterns (A, B, C, D, E, F, G) 22a.

Additionally, for example, when the same pattern is held in pattern sets respectively corresponding to different distribution key values for an event in a detection server, the real data of the patterns may be shared. For example, the patterns A, B, C, D, E, and F are in common in the pattern sets 22a and 22b in the detection server 21a. Therefore, the detection server 21a may share data of these patterns for both of the pattern sets 22a and 22b.

When a load becomes uneven in the detection server 21a in the system according to this embodiment, it is conceivable to move part of the pattern matching process, namely, a load, executed by the detection server 21a, to a different detection server so that the load may be lightened.

However, when the pattern matching process is moved to the different detection server in units of pattern sets, it is expected that the amount of the process will exceed an allowable amount of the process of a detection server at a move destination and that the load will become uneven in the detection server at the move destination.

Accordingly, it is conceivable to extract part of the pattern set from the detection server 21a, and to move, to the different detection server 21b, a combination of the extracted part of the pattern set and a distribution key value of the event corresponding to the pattern. In the case of FIG. 5, the extracted part 23 (patterns B, H) of the pattern set of the event, and a distribution key value=4 of the event are moved from the detection server 21a to the detection server 21b. As a result, not only the detection server 21a but also the detection server 21b can execute the pattern matching process for the event to which the distribution key value=4 is assigned.

In this case, the transfer server 24 multicasts an event to all detection servers 21 when the identification value (the distribution key value) assigned to event data of the event received in real time is “4”. Upon receipt of the event data of the event to which the distribution key value=4 is assigned from the transfer server 24, the detection servers 21a, 21b responsible for an event having the distribution key value=4 execute the pattern matching process by using a pattern set corresponding to the distribution key value of the event.

When the number of detection servers responsible for an event having the same distribution key value becomes plural, the event is multicast as described above. Therefore, the volume of traffic of a network increases. For this reason, it is preferable to take into account an influence of an increase in the volume of traffic before part or the whole of a pattern set is moved.

As described above, in this embodiment, an event type of input event data, and a distribution key value are used as identification information, the identification information and a pattern corresponding to the identification information are used as one combination, and which combination is moved to which server is controlled so that an optimum distribution process can be implemented. As a consequence, a load distribution is dynamically performed with more flexibility (effective and efficient leveling is implemented) by using an event type of input event data, an identification value, and a pattern as a unit of a move process, whereby a low latency and a high throughput can be maintained. Namely, loads of detection servers can be effectively leveled.

Moreover, when a combination of an event type of input event data, an identification value, and a pattern is moved and the same pattern data is already present at a move destination, there is no need to transmit the pattern data. Accordingly, a leveling cost can be reduced, whereby efficient leveling can be realized.

This embodiment is described in detail below.

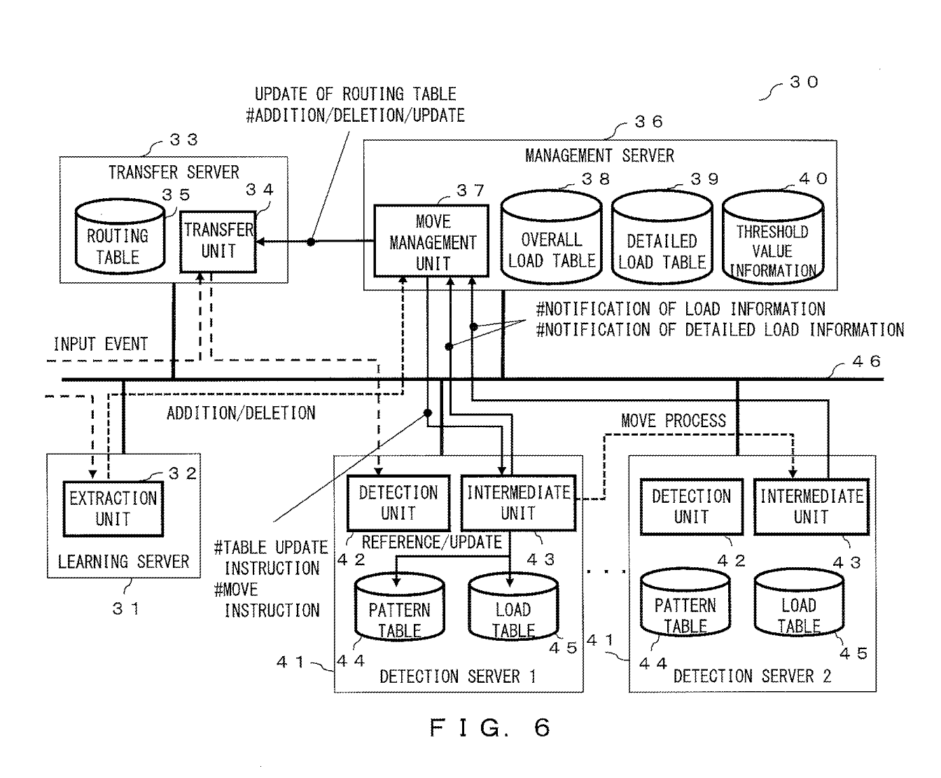

FIG. 6 illustrates an example of an event detection system according to this embodiment. The event detection system (hereinafter abbreviated to “system” in some cases) 30 includes a learning server 31, the transfer server 33, the management server 36, and a plurality of detection servers 41 (41a, 41b, . . . ). The learning server 31, the transfer server 33, the management server 36, and the plurality of detection servers 41 are connected by a communication network 46 such as the Internet, a LAN (Local Area Network), or the like. The learning server 31, the transfer server 33, the management server 36, and the plurality of detection servers 41 (41a, 41b, . . . ) respectively include a processor, a memory, a storage device, a communication interface, and the like.

The learning server 31 includes an extraction unit 32. The extraction unit 32 is implemented by the processor of the learning server 31. The extraction unit 32 extracts a pattern to be detected from event data received via the communication network 46 or already defined information, and notifies the management server 36 of an event type of the extracted pattern and a distribution key value. The extraction unit 32 also notifies the management server 36 of a pattern not to be detected.

The management server 36 includes the move management unit 37, an overall load table 38, a detailed load table 39, and threshold value information 40. The overall load table 38, the detailed load table 39, and the threshold value information 40 are stored in the memory or the storage device of the management server 36. The overall load table 38 stores load information (sum(Tproc), sum(Tcomm)) respectively transmitted from the detection servers 41 (41a, 41b, . . . ) in units of detection servers 41.

Tproc indicates a detection process cost, notified from each of the detection servers 41 (41a, 41b, . . . ), relating to a distribution key value of a specified event per unit time. sum(Tproc) indicates a total of Tproc transmitted from all the detection servers 41.

Tcomm indicates an input communication cost, reported from each of the detection servers 41 (41a, 41b, . . . ), relating to a distribution key value of a specified event per unit time. sum(Tcomm) indicates a total of Tcomm transmitted from all the detection servers 41.

The overall load table 38 is used to determine an allocation and a moving of a pattern. The load information (sum(Tproc), sum(Tcomm)) will be described in detail later.

The detailed load table 39 stores information of the pattern table 44 transmitted from each of the detection servers 41. As will be described later, the threshold value information 40 holds a lower limit threshold value and an upper limit threshold value of sum(Tproc), a lower limit threshold value and an upper limit threshold value of sum(Tcomm), and an upper limit threshold value of total(sum(Tcomm).

The move management unit 37 is implemented by the processor of the management server 36. The move management unit 37 references the overall load table 38 and the detailed load table 39, and determines whether a state of any of the detection servers or the event detection system satisfies conditions to be described later.

When the state of none of the detection servers or the event detection system satisfies any of the conditions to be described later, the move management unit 37 estimates which combination of an event type, a distribution key value and a pattern is allocated and moved to which server in order to satisfy any of the conditions. Then, the move management unit 37 moves the combination of the event type, the distribution key value, and the pattern on the basis of the estimated information.

When a notification of the new combination, extracted by the extraction unit 32 of the learning server 31, of the event type, the distribution key value, and the pattern is issued from the learning server 31, the move management unit 37 decides, as a responsible detection server, a detection server having the lightest load by referencing the overall load table 38. The move management unit 37 notifies the transfer server 33 of the responsible detection server, the event type, and the distribution key value.

Additionally, when the new load is allocated, the move management unit 37 transmits a table update instruction including the event type, the distribution key value, and the pattern to the responsible detection server 41.

Furthermore, when part of a pattern set corresponding to the combination of the event type and the distribution key value is split and the part of the pattern set and the combination of the event type and the distribution key value are moved to a different detection server, the move management unit 37 issues a move instruction to a move source detection server. The move instruction includes the event type, the distribution key value, the pattern name, and address information of the server at the move destination.

Still further, the move management unit 37 updates the overall load table 38 and the detailed load table 39 on the basis of the notification issued from the detection server 41.

The transfer server 33 includes a transfer unit 34 and a routing table 35. The routing table 35 is stored in the memory or the storage device of the transfer server 33. The routing table 35 holds, for each event type and distribution key value, information indicating which detection server is responsible for a pattern matching process of an event corresponding to a distribution key value of the event.

The transfer unit 34 is implemented by the processor of the transfer server 33. The transfer unit 34 accepts an input of event data, and transfers the event data (unicasts the event data when the number of transfer destinations is one, or multicasts when the number of transfer destinations is plural) to a detection server 41 stored in the routing table 35 in accordance with the event type and the distribution key value. The transfer unit 34 accepts a request to update the routing table 35 from the management server 36.

The detection server 41 includes a detection unit 42, an intermediate unit 43, a pattern table 44 and a load table 45. The pattern table 44 and the load table 45 are stored in the memory or the storage device of the detection server 41.

The load table 45 holds a pattern name for identifying a pattern to be detected, and information of Tproc and Tcomm by defining a combination of an event type and a distribution key value as unique information.

The pattern table 44 holds real data of a pattern. The pattern table 44 is accessed by using a pattern name of the load table 45 as a key. A data structure of the real data of a pattern varies depending on a detection method.

Upon receipt of input event data transmitted from the transfer server 33, the detection unit 42 extracts a pattern from the input event data, and makes a comparison between the extracted pattern and a pattern registered in the pattern table 44.

Upon receipt of the instruction to update the table or the move instruction from the management server 36, the intermediate unit 43 updates the load table 45 or the pattern table 44. Moreover, when the received instruction is the move instruction, the intermediate unit 43 moves a combination of an event type, a distribution key value, and a pattern corresponding to the distribution key value to a different detection server in units of combinations.

Additionally, the intermediate unit 43 notifies the management server 36 of load table information (sum(Tcomm), sum(Tproc)) at specified time intervals in order to determine a move in the management server 36. Moreover, the intermediate unit 43 notifies the management server 36 of detailed load information (including an event type, a distribution key value, a pattern name, Tproc and Tcomm) on the basis of a request from the management server 36.

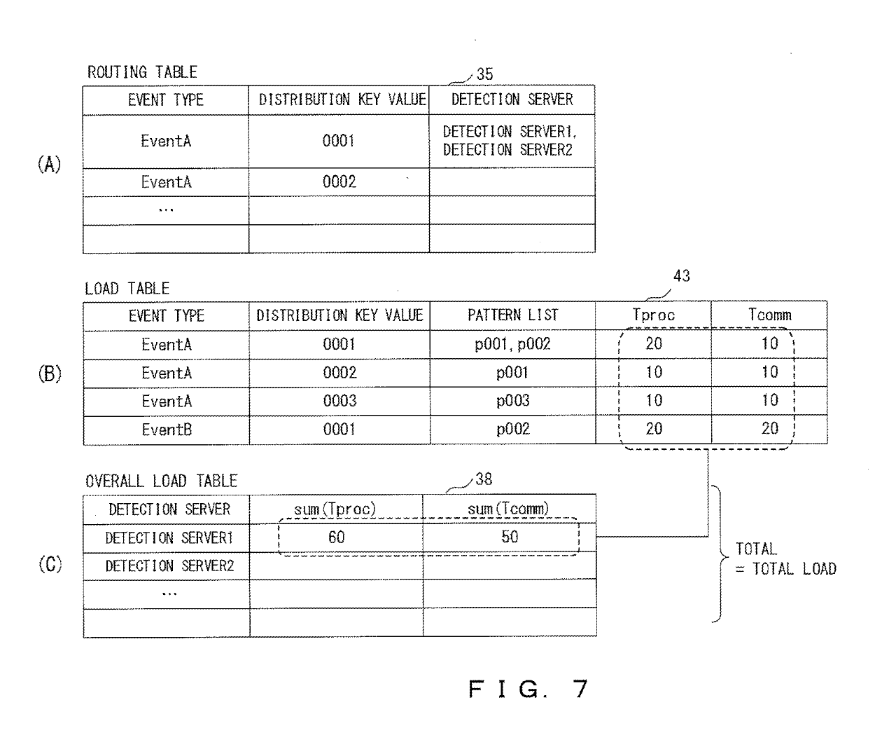

FIG. 7 illustrates examples of the routing table, the load table, and the overall load table that are used in the event detection system according to this embodiment.

The routing table 35 illustrated in FIG. 7(A) is used to transmit input event data received by the transfer server 33 to a detection server at a transfer destination responsible for a combination of an event type and a distribution key value assigned to the input event data.

The routing table 35 includes data entries such as an “event type”, a “distribution key value”, and a “detection server”. The entry “event type” indicates a type of an event. The entry “distribution key value” indicates a distribution key value assigned to the event.

The entry “detection server” stores an IP (Internet Protocol) address or the like of a detection server at a transfer destination of the event. The entry “detection server” can store addresses of a plurality of detection servers as a list. When a plurality of detection servers are registered in the entry “detection server” as transmission destinations corresponding to the event type and the distribution key value, the transfer unit 34 multicasts the event data to the plurality of detection servers. In the meantime, when one detection server is registered in the entry “detection server” as a transmission destination corresponding to the event type and the distribution key value, the transfer unit 34 unicasts the event data.

The load table 45 illustrated in FIG. 7(B) is used to manage load information of each pattern list corresponding to a combination of an event type and a distribution key value of each detection server. The load table 45 includes data entries such as an “event type”, a “distribution key value”, a “pattern list”, “Tproc” and “Tcomm”.

The entry “event type” indicates a type of an event. The entry “distribution key value” indicates a distribution key value assigned to the event.

The entry “pattern list” stores one or more pattern names for identifying a pattern. The entry “pattern list” is a list of a pattern set including one or more patterns corresponding to a combination of an event type and a distribution key value. Real data corresponding to a pattern name is stored in the pattern table 44.

The entries “Tproc” and “Tcomm” store parameters used as a matrix for determining a move.

“Tcomm” indicates an input communication cost of an event for each distribution key value of a specified event per unit time. Tcomm differs depending on a distribution key value of an event. However, since Tcomm is multicast to a detection server group responsible for the dispersion key value of the event, it is constant in all detection servers for the same distribution key value of the same event. However, Tcomm is 0 in a server for a distribution key value of an event that the server is not responsible for. Tcomm may be calculated for each detection server. However, since Tcomm is constant, it is more desirable to manage Tcomm at one site (an input adapter or the like). Tcomm is proportional to an input frequency. For example, a communication cost of a certain distribution key value=a is

Tcomm(a)=k1*n(a)

(k1: coefficient (a communication cost per input. Depends on a communication factor cost such as serialization, and a data size), n: input frequency (the number of input events to a distribution key value of a specified event))

“Tproc” indicates a detection processing cost for each distribution key value of a specified event per unit time. Tproc differs depending on a detection server also for the same distribution key value of a specified event. Unlike Tcommm, Tproc is calculated for each detection server because the number of detection patterns for a distribution key value varies depending on a detection server. Tproc is proportional to an input frequency and the number of patterns. For example, a detection processing cost of a distribution key value=a of a certain event is

Tproc(a)=k2*n(a)*np(a)

(k2: coefficient (a detection processing cost per input. Depends on a data type, a size, content of a process, or the like), n: input frequency (the number of input events for a distribution key value of a specified event), np: the number of patterns)

The intermediate unit 43 of the detection server 41 respectively summates “Tproc” and “Tcomm” of the load table 45 as (sum(Tcomm), sum(Tproc)), and transmits the summated sum(Tcomm) and sum(Tproc) to the management server 36 as load information.

The overall load table 38 is used to manage the load information transmitted from the detection servers 41. The overall load table 38 includes data entries such as a “detection server”, “sum(Tproc)” and “sum(Tcomm)”. The entry “detection server” stores information for identifying a detection server. The entry “sum(Tproc)” stores sum(Tproc) transmitted from the detection server 41. The entry “sum(Tcomm) stores sum(Tcomm) transmitted from the detection server 41. Here, the total traffic of sum(Tcomm) of all the servers is represented as total(sum(Tcomm)).

A move determination is described next. sum(Tproc) and sum(Tcomm) are threshold values for leveling loads of detection servers, and an upper limit threshold value and a lower limit threshold value are respectively set for sum(Tproc) and sum(Tcomm). The upper limit threshold value is a value with which it is determined that a load is too heavy, namely, a further process cannot be permitted in a detection server. Preferably, the upper limit threshold value is 60 to 80 percent of a resources use rate. The lower limit threshold value is a value with which it is determined that a surplus of resources is too large or use efficiency is low in a detection server. When a load of a detection server is lower than the lower limit threshold value, the detection server receives a process if circumstances permit even when other detection servers do not reach the upper limit threshold value. Preferably, the lower limit threshold value is 10 to 30 percent of the resources use rate.

total (sum(Tcomm)) is a threshold value used when it is determined that the entire traffic is to be reduced, and an upper limit threshold value is set for total (sum(Tcomm)).

The management server 36 controls the load imposed on the entire event detection system so that the following three conditions may be satisfied.

First condition: the detection processing cost (sum(Tproc)) of each detection server falls within a range between the lower limit threshold value and the upper limit threshold value.

Second condition: the communication cost (sum(Tcomm)) of each detection server falls within a range between the lower limit threshold value and the upper limit threshold value.

Third condition: the total (total(sum(Tcomm)) of sum(Tcomm) of all the servers is equal to or smaller than the upper limit threshold value.

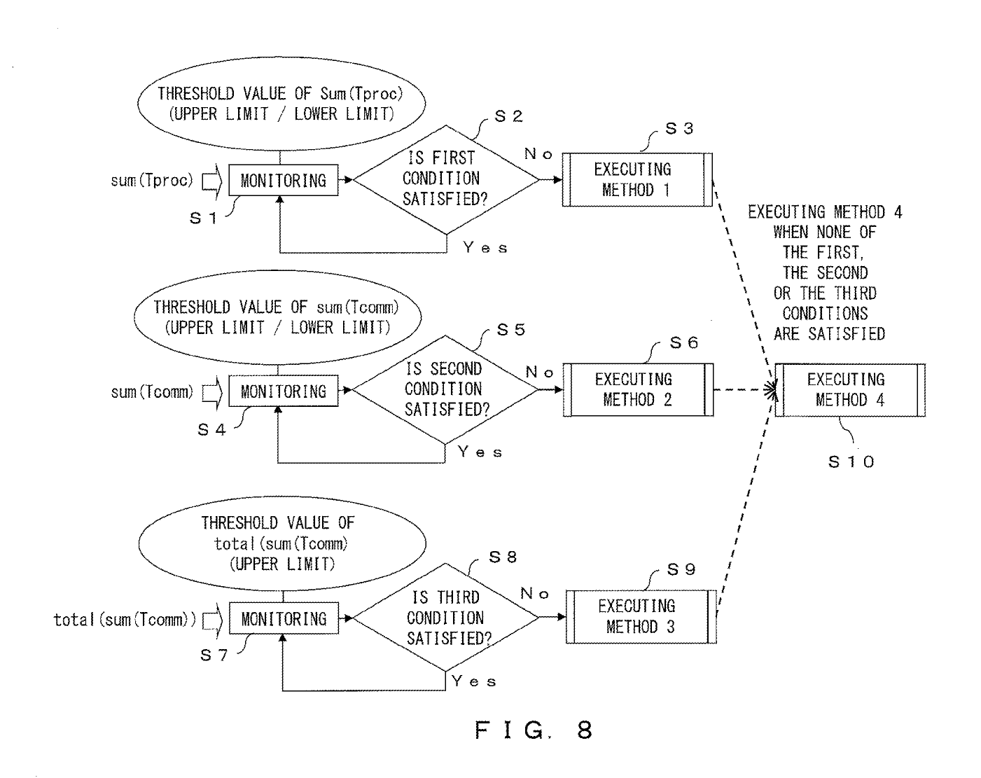

When any of the above described conditions is not satisfied, the management server 36 performs a control such that a process is moved by using any of methods 1 to 4 corresponding to the unsatisfied condition, as will be described later with reference to FIG. 8. In this case, a combination of servers at a move source and a move destination, an event type of an event to be moved, a distribution key value, and a pattern name is selected.

FIG. 8 illustrates a flow for executing methods 1 to 4 depending on whether a monitoring target in this embodiment satisfies a corresponding condition. The move management unit 37 obtains the lower limit threshold value and the upper limit threshold value of sum(Tproc), the lower limit threshold value and the upper limit threshold value of sum(Tcomm), and the upper limit threshold value of total(sum(Tcomm)). These threshold values are registered in the threshold value information 40.

The management server 36 receives load information (sum(Tproc), sum(Tcomm)) transmitted from each of the detection servers 41 at specified time intervals, and stores the information in the overall load table 38. Then, the move management unit 37 of the management server 36 references the overall load table 38 at specified time intervals, and monitors sum(Tproc) and sum(Tcomm) of each of the detection servers 41, and a total total (sum(Tcomm)) of all the servers (S1, S4, S7).

In the monitoring, the move management unit 37 compares a range between the lower limit threshold value and the upper limit threshold value of sum(Tproc) with sum(Tproc) of each of the detection servers 41 (S2). Moreover, the move management unit 37 compares a range between the lower limit threshold value and the upper limit threshold value of sum(Tcomm) with sum(Tcomm) of each of the detection servers 41 (S5). Additionally, the move management unit 37 compares the upper limit threshold value of total (sum(Tcomm)) with the total total (sum(Tcomm)) of sum(Tcomm) of all the servers (S8).

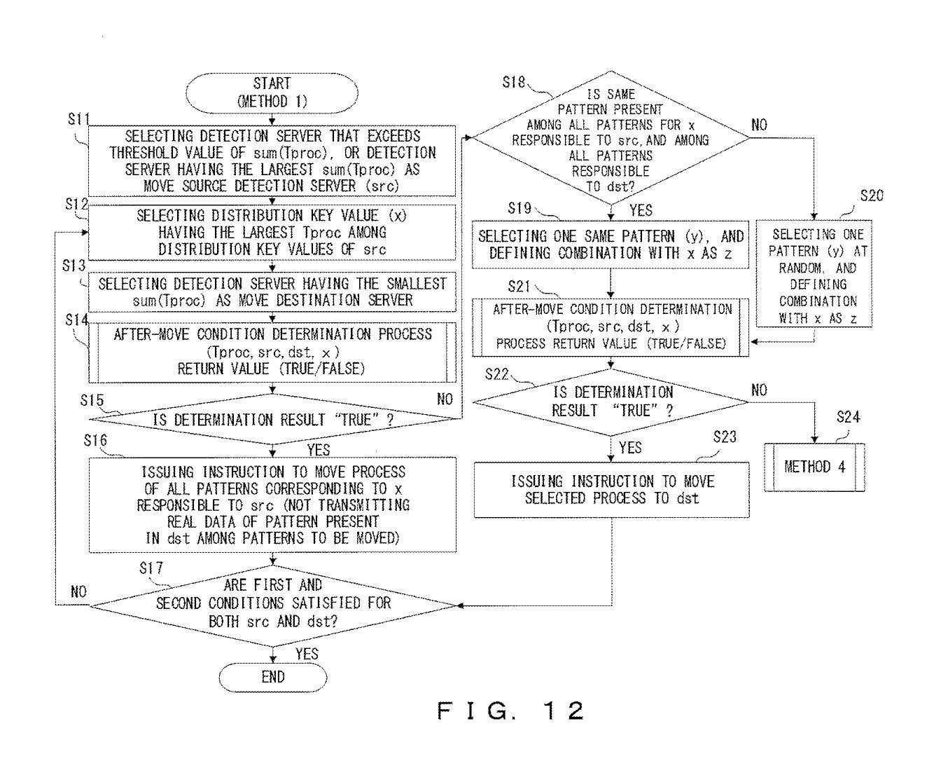

When the move management unit 37 determines that the detection processing cost (sum(Tproc)) of each of the detection servers exceeds the range between the lower limit threshold value and the upper limit threshold value as a result of the monitoring, namely, when the first condition is not satisfied (“NO” in S2), the move management unit 37 executes method 1 (S3) (FIG. 12).

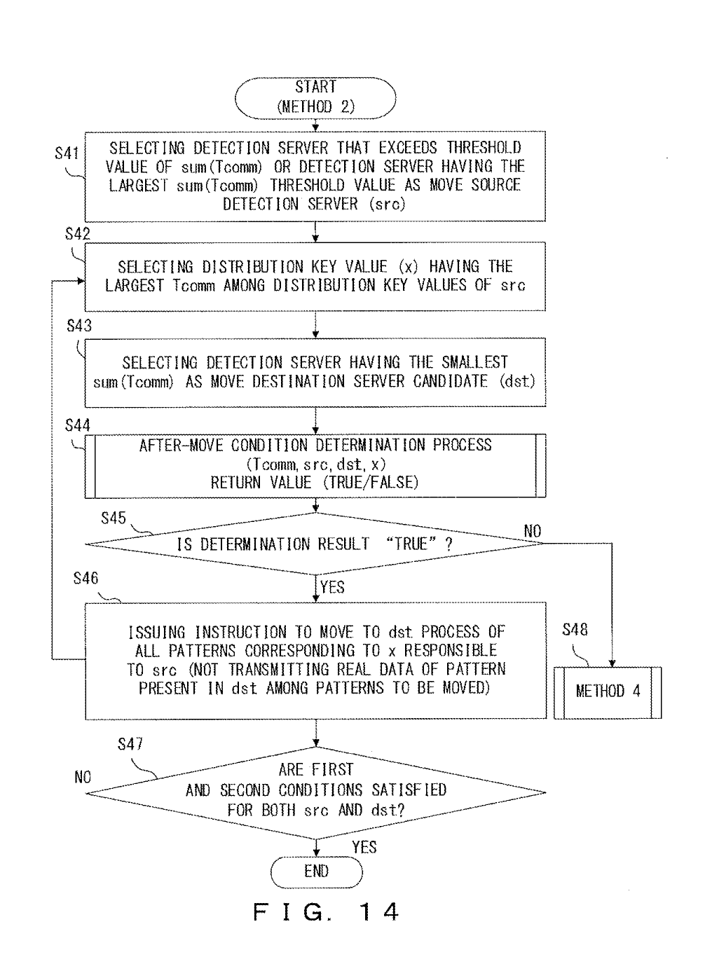

When the move management unit 37 determines that the communication cost (sum(Tcomm)) of each of the detection servers exceeds the range between the lower limit threshold value and the upper limit threshold value as a result of the monitoring, namely, when the second condition is not satisfied (“NO” in S5), the move management unit 37 executes the second method 2 (S6) (FIG. 14).

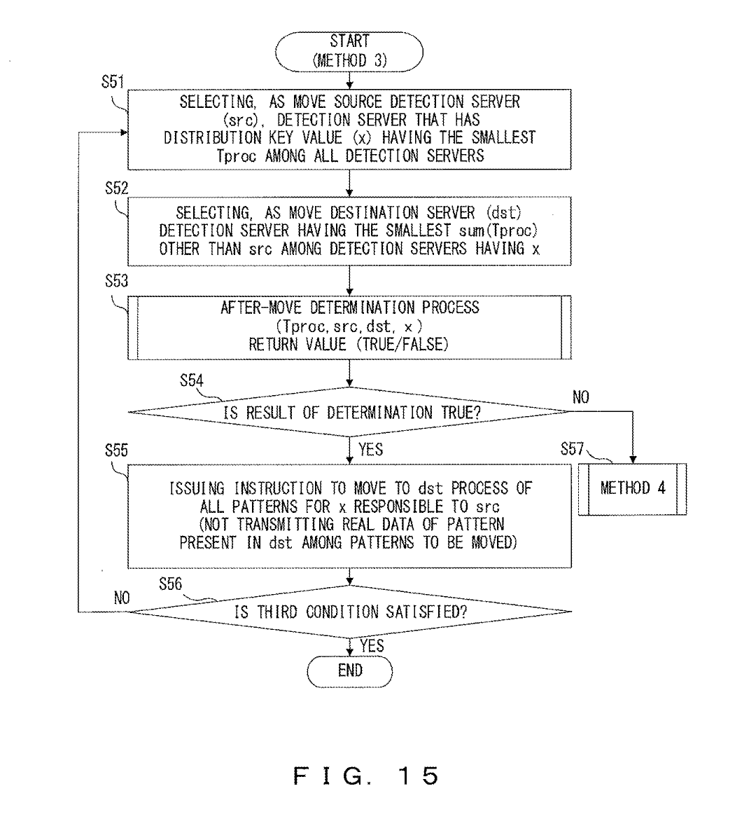

When the move management unit 37 determines that the total(total(sum(Tcomm)) of sum(Tcomm) of all the servers exceeds the upper limit threshold value as a result of the monitoring, namely, when the third condition is not satisfied (“NO” in S8), the move management unit 37 executes method 3 (S9) (FIG. 15).

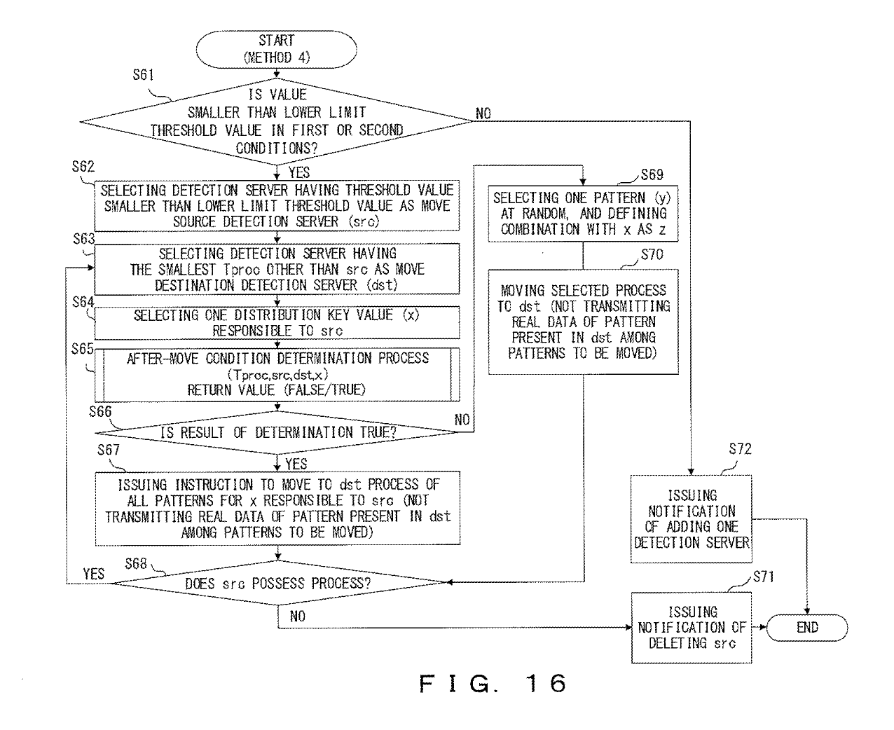

When none of the first to the third conditions that respectively correspond to methods 1 to 3 are satisfied even though methods 1 to 3 are executed, the move management unit 37 executes method 4 (S10) (FIG. 16).

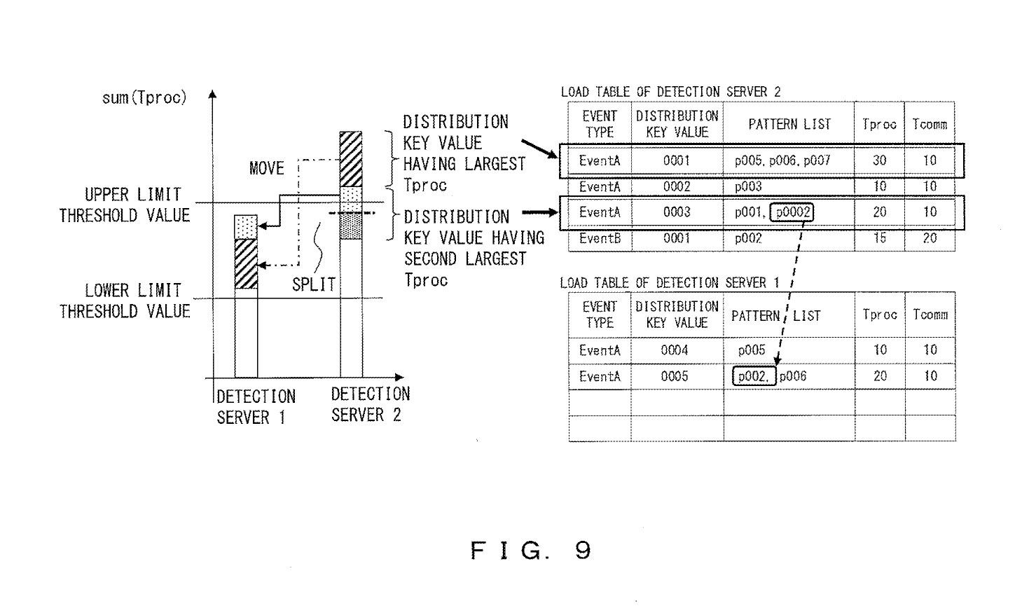

FIG. 9 is an explanatory diagram of method 1 executed in this embodiment. Method 1 is applied when the first condition is not satisfied.

When a server having sum(Tproc) that exceeds the upper limit threshold value is present, the management server 36 selects a server that exceeds the upper limit threshold value and a server having the smallest sum(Tproc) respectively as servers at a move source and a move destination.

When a server having a sum(Tproc) that is smaller than the lower limit threshold value is present, the management server 36 selects the server having a sum(Tproc) that is smaller than the lower limit threshold value and a server having the largest sum(Tproc) respectively as servers at a move destination and a move source.

The management server 36 selects distribution key values of an event having Tproc in descending order of Tproc in the server at the move source. However, the management server 36 estimates sum(Tproc) of the servers at the move source and the move destination after a combination is moved before the combination of a selected distribution key value and a pattern of the selected event is actually moved. When the first and the second conditions are not satisfied, the management server 36 splits some of patterns from a pattern list corresponding to the distribution key value of the event as pattern candidates to be moved.

As a candidate of a pattern to be moved, the same pattern as that possessed by the detection server at the move destination is used with a higher priority. Thus, an existing pattern at the move destination can be shared without moving actual data of the same pattern, whereby a cost needed to move the pattern can be reduced. Moreover, also when the patterns are split, sum(Tproc) of the servers at the move source and the move destination needed after the combination is moved are similarly estimated before the combination is moved. When the first condition cannot be satisfied as a result of the estimate, the management server 36 executes method 4.

For example, in the case of FIG. 9, upon detection of a detection server 2 having sum(Tproc) that exceeds the upper limit threshold value, the management server 36 selects a load of a distribution key value (“EventA”, “0001”) of an event having the largest Tproc from detailed load information notified from the detection server 2.

However, even though the load of the distribution key value (“EventA”, “0001”) of the event having the largest Tproc is moved to the detection server 1, sum(Tproc) of the detection server 2 still exceeds the upper limit threshold value. Therefore, the management server 36 next selects a load of a distribution key value (“Event A”, “0003”) of an event having the second largest Tproc.

However, when the entirety of the selected load is moved, Tproc of the detection server 1 exceeds the upper limit threshold value. Therefore, the management server 36 further splits a load (a pattern list) in the selected load. The management server 36 selects the same pattern “p002” as that possessed by the detection server at the move destination with a higher priority when the management server 36 splits the pattern list. The management server 36 moves, to the detection server 1, the combination of the distribution key value (“EventA”, “0003”) of the event and the pattern name “p002”.

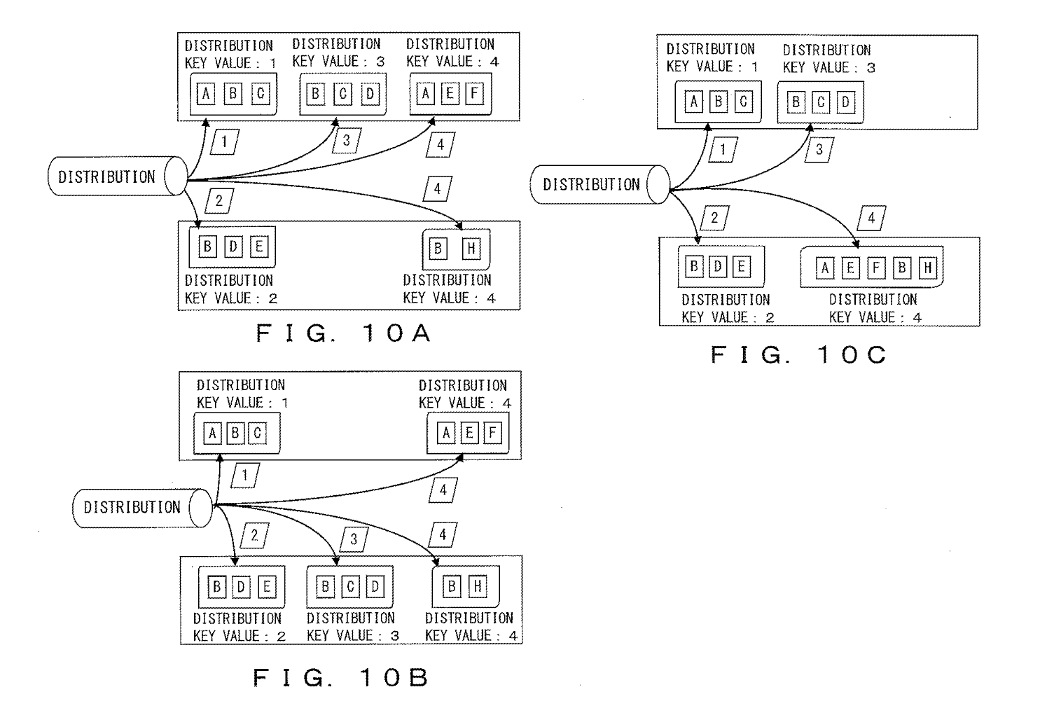

FIGS. 10A-10C are explanatory diagrams of method 2 executed in this embodiment. Method 2 is applied when the second condition is not satisfied. FIG. 10A illustrates an example of states of the detection servers 1, 2 before method 2 is applied.

When a server having sum(Tcomm) that exceeds the upper limit threshold value is present, the management server 36 selects the server having sum(Tcomm) that exceeds the upper limit threshold value and that having the smallest sum(Tproc) respectively as servers at a move source and a move destination.

When a detection server having sum(Tcomm) that is smaller than the lower limit threshold value is present, the management server 36 selects the server having sum(Tcomm) that is smaller than the lower limit threshold value and that having the largest sum(Tcomm) respectively as servers at a move destination and a move source.

The management server 36 selects a distribution key value of an event having Tcomm in descending order of Tcomm in the server at the move source. However, event data of a distribution key value of a split event is multicast even though the event is split and moved as in method 1. Therefore, Tcomm is not reduced. Accordingly, with method 2, the management server 36 moves all patterns corresponding to the split key value=3 in order to reduce Tcomm as illustrated in FIG. 10B. As a result, Tproc of the move source detection server is reduced.

Additionally, a case where not only the move source detection server but also that at the move destination holds the same distribution key value is considered. As illustrated in FIG. 10C, the detection server 2 at the move destination has originally received specified event data having the distribution key value=4. Therefore, the patterns corresponding to the distribution key value=4 of the specified event can be moved from the detection server 1 at the move source to the detection server 2 at the move destination without increasing Tcomm of the server at the move destination.

As a pattern to be moved, the same pattern as that possessed by the detection server at the move destination is used with a higher priority, similarly to method 1. Thus, an existing pattern at the move destination can be shared without moving the same pattern, whereby a cost needed to move the pattern can be reduced.

The above described ways for moving patterns are taken into account, and a combination having Tcomm starts to be moved in descending order of Tcomm as in method 1. At this time, similarly to method 1, the management server 36 selects a combination of an event type, a distribution key value and a pattern before the combination is moved, and estimates sum(Tcomm) of the servers at the move source and the move destination after the combination is moved. When the second condition cannot be satisfied as a result of the estimate, the management server 36 executes method 4.

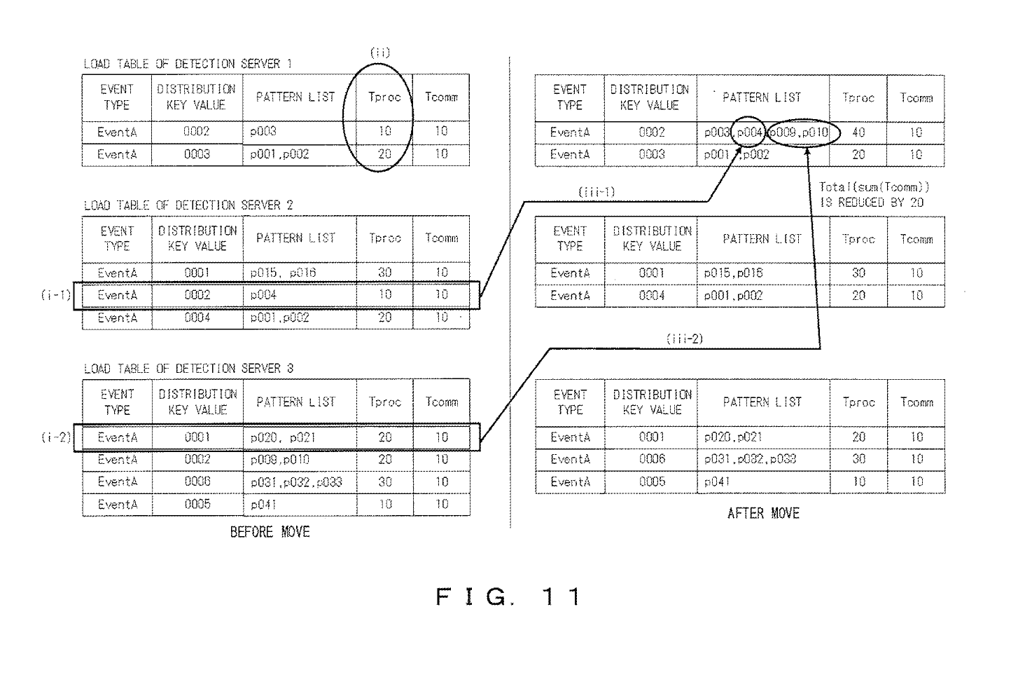

FIG. 11 is an explanatory diagram of method 3 executed in this embodiment. Method 3 is a method for reducing total(sum(Tcomm)), and is applied when the third condition is not satisfied.

When a state where the first condition is not satisfied continues, a pattern set continues to be split in a wider range, so that the number of times that an event is multicast increases. This leads to a situation where the volume of traffic (total (sum(Tcomm))) increases as the entire system increases. In this situation, there is a high probability that the second condition cannot be satisfied even though any combination of an event type, a distribution key value and a pattern may be moved to any server when a load increases. Also with method 2, preventing a load of the entire network (total(sum(Tcomm)) from being increased is taken into account.

With method 3, the management server 36 aggregates combinations of an event type having a smaller Tproc, a distribution key value, and a pattern in the same server. There is also a method for adding a server. However, it is preferable to initially make an attempt to rearrange servers in terms of resources efficiency. Moreover, a load imposed by a combination of a distribution key value and a pattern of an event having a smaller Tproc can be moved with ease. Additionally, similarly to methods 1 and 2, a load is selected so that the first and the second conditions may be satisfied after the load is moved.

In FIG. 11, (i (i−1, i−2)) a detection server having the smallest Tproc is selected as a move source server, and combinations of the Tproc, an event type, and a distribution key value are (sequentially) selected. (ii) Next, a detection server having the smallest sum(Tproc) other than the detection server selected as the server at the move source is selected as the server at the move destination, and combinations of an event type, a distribution key value, and Tproc are (sequentially) selected. (iii) In the server at the move source, a detection server having the smallest Tproc is (sequentially) moved in a selected combination of an event type, a distribution key value, and Tproc. The above described (i) to (iii) are nested and executed as a loop until the third condition is satisfied. As a result, the load imposed on the entire network total (sum(Tcomm)) is reduced by 20 in FIG. 11.

Method 4 is described next. When the first, the second, or the third condition is not satisfied even though method 1, 2 or 3 is executed, a load imposed on a detection server or the entire system is adjusted by adding or deleting a detection server. This is defined as method 4. Namely, when a load exceeds the upper limit threshold value in the first, the second or the third condition, a detection server is added. Alternatively, when the load becomes smaller than the lower limit threshold value in the first, the second or the third condition, a detection server is deleted from the system.

A move of a combination of an event type, a distribution key value and a pattern to the added detection server, and a move of a combination of an event type, a distribution key value and a pattern from a detection server to be deleted are performed with procedures similar to those of method 1, 2 or 3.

FIG. 12 illustrates a flow of the load move process that uses method 1 and is executed by the move management unit of the management server in this embodiment. The flow of FIG. 12 represents details of the process of S3 illustrated in FIG. 8.

The move management unit 37 references the overall load table 38, and selects a detection server having sum(Tproc) that exceeds the upper limit threshold value or a detection server having the largest sum(Tproc) as a move source detection server (src) (S21). The move management unit 37 issues a request to transmit content of the load table 45 to the move source detection server (src), and stores detailed load information obtained as a response in the detailed load table 39.

The move management unit 37 references the detailed load table 39, and selects a distribution key value (x) having the largest Tproc among distribution key values of an event of the move source detection server (src) (S22).

The move management unit 37 references the overall load table 38, and selects a detection server having the smallest sum(Tproc) as a move destination server candidate (dst) (S13). The move management unit 37 issues a request to transmit content of the load table 45 to the selected move destination server candidate (dst), and stores detailed load information obtained as a response in the detailed load table 39.

The move management unit 37 executes an after-move condition determination process for determining whether the first condition is satisfied when it is assumed that a pattern matching process (load) corresponding to a distribution key value (x) of an event is moved from the move source detection server (src) to the move destination server candidate (S14).

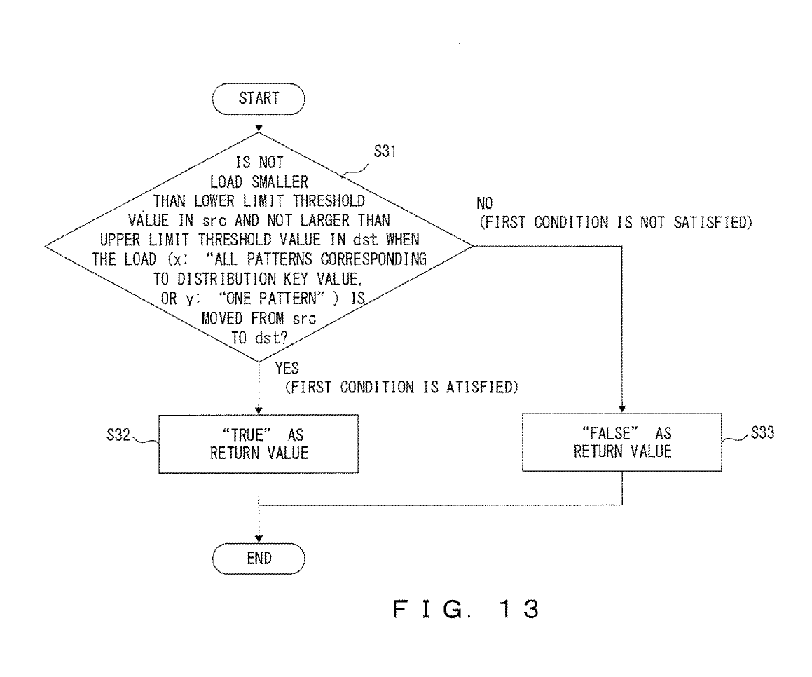

As input parameters to the after-move condition determination process of S14, Tproc (=coefficient k2×input frequency n×the number of patterns corresponding to a distribution key value (x) of an event), the move source detection server (src), the move destination server candidate (dst), an event type, and the distribution key value (x) are input. The process of S14 will be described in detail with reference to FIG. 13.

When a return value of the after-move condition determination process of S14 is “true” (when the move management unit 37 determines that the first condition is satisfied) (“YES” in S15), the move management unit 37 executes the following process. Namely, the move management unit 37 issues a move instruction to the move source detection server (src) so that the process of all patterns corresponding to the distribution key value (x) of the event that the move source detection server (src) is responsible for may be moved to the move destination server candidate (dst) (S16).

At this time, the move management unit 37 references a pattern list of the detailed load information, stored in the detailed load table 39, of the move destination detection server (dst), and determines whether each pattern name corresponding to the distribution key value (x) of the event to be moved is included in the pattern list.

When all pattern names corresponding to the distribution key value (x) of the event to be moved are included in the pattern list of the move destination detection server (dst), the move management unit 37 executes the following process. Namely, the move management unit 37 incorporates not an instruction to transmit real data corresponding to the pattern names but an instruction to transmit the pattern names into the move instruction.

In the meantime, when a pattern name that is not included in the pattern list of the move destination detection server (dst) is present among the pattern names corresponding to the distribution key value(x) of the event to be moved, the move management unit 37 executes the following process. Namely, the move management unit 37 incorporates an instruction to transmit the pattern name and an instruction to transmit real data corresponding to the pattern name into the move instruction.

Upon receipt of the move instruction from the management server 36, the intermediate unit 43 of the move source detection server (src) transmits all the pattern names corresponding to the distribution key value (x) of the event to be moved to the move destination detection server (dst) on the basis of the move instruction. When the instruction to also move the real data corresponding to the pattern names to be moved is incorporated into the move instruction, the intermediate unit 43 also transmits the real data of the patterns.

After the combination of the event type, the distribution key value (x), and the pattern is moved, the move source detection server (src) and the move destination detection server (dst) respectively update the load table 45. As a result, the load to be moved is moved from the move source detection server (src) to the move destination detection server (dst). Accordingly, the process that uses the moved combination of the event type, the distribution key value, and the pattern is executed not by the move source detection server (src) but also by the move destination detection server (dst). Moreover, the move source detection server (src) and the move destination detection server (dst) respectively notify the management server 36 of the load information (sum(Tcomm), sum(Tproc)) on the basis of the updated load table 45.

The move management unit 37 updates the overall load table 38 on the basis of the load information (sum(Tcomm), sum(Tproc)) received from the move source detection server (src) and the move destination detection server (dst).

The move management unit 37 determines whether both the move source detection server (src) and the move destination detection server (dst) satisfy the first and the second conditions (S17). Namely, the move management unit 37 references the overall load table 38, and determines, for both the move source detection server (src) and the move destination detection server (dst), whether (sum(Tproc)) falls within a range between the lower limit threshold value and the upper limit threshold value, and whether sum(Tcomm) falls within a range between the lower limit threshold value and the upper limit threshold value.

When neither the first condition nor the second condition is satisfied for the move source detection server (src) and the move destination detection server (dst) (“NO” in S17), the flow returns to S2. When the first and the second conditions are satisfied in both the move source detection server (src) and the move destination detection server (dst) (“YES” in S17), this flow is terminated.

When the return value of the after-move condition determination process of S14 is “false” (when the move management unit 37 determines that the first condition is not satisfied) (“NO” in S15), the move management unit 37 references detailed load information, stored in the detailed load table 39, of the move source detection server (src), and executes the following process. Namely, the move management unit 37 determines whether the same pattern name is present among all pattern names within the pattern list corresponding to the distribution key value (x) of the event of the move source detection server (src), and among all pattern names within the list of all patterns of the move destination detection server (dst) (S18).

When the same pattern name is present among all the pattern names corresponding to the distribution key value (x) of the event of the move source detection server (src), and among all the pattern names within the list of all the patterns of the move destination detection server (dst) (“YES” in S18), the move management unit 37 executes the following process. Namely, the move management unit 37 selects the same pattern name (y) from among all the pattern names within the pattern list corresponding to the distribution key value (x) of the event of the move source detection server (src), and defines a combination of the pattern name (y), the event type, and the distribution key value (x) as z (S19).

When the same pattern name is present among none of the pattern names that the move source detection server (src) is responsible for and the pattern names that the move destination detection server (dst) is responsible for (“NO” in S8), the move management unit 37 executes the following process. Namely, the move management unit 37 selects one pattern name (y) at random from all the pattern names corresponding to the distribution key value (x) of the event that the move source detection server (src) is responsible for, and defines a combination of the pattern name (y), the event type, and the distribution key value (x) as z (S20).

The move management unit 37 executes the after-move condition determination process (Tproc, src, dst, z) after the process of S19 or S20 (S21). As input parameters (=coefficient k2×input frequency n×the number of selected patterns), the move source detection server (src), the move destination server candidate (dst), and the combination z of the pattern name (y), the event type, and the distribution key value (x) are input. The process of S21 will be described in detail with reference to FIG. 13.

When the return value of the after-move condition determination process of S21 is “true” (when the move management unit 37 determines that the first condition is satisfied) (“YES” in S22), the move management unit 37 executes the following process. Namely, the move management unit 37 issues a move instruction to the move source detection server (src) so that the process (load) of the combination z of the selected pattern (y), the event type, and the distribution key value (x) may be moved to the move destination server candidate (dst) (S23).

At this time, when the pattern name selected in S19 is already present in the move destination detection server (dst), the move management unit 37 does not incorporate an instruction to transmit real data corresponding to the pattern name into a move instruction. In the meantime, when the pattern selected in S19 is already present in the move destination detection server (dst), the move management unit 37 incorporates the instruction to transmit the real data corresponding to the pattern name into the move instruction.

Upon receipt of the move instruction from the management server 36, the intermediate unit 43 of the move source detection server (src) transmits the pattern name corresponding to the distribution key value (x) of the event to be moved to the move destination detection server (dst). When the instruction to move the real data corresponding to the pattern name to be moved is also incorporated into the move instruction, the intermediate unit 43 also transmits the real data of the pattern.

After the combination of the event type, the distribution key value (x) and the pattern is moved, the move source detection server (src) and the move destination detection server (dst) respectively update the load table 45. As a result, the load to be moved is moved from the move source detection server (src) to the move destination detection server (dst). Accordingly, the process using the moved combination of the event type, the distribution key value, and the pattern is executed not by the move source detection server (src) but by the move destination detection server (dst). Moreover, the move source detection server (src) and the move destination detection server (dst) respectively notify the management server 36 of load information (sum(Tcomm), sum(Tproc)) on the basis of the updated load table 45.

The move management unit 37 updates the overall load table 38 on the basis of the load information (sum(Tcomm), sum(Tproc)) received from the move source detection server (src) and the move destination detection server (dst). After the process of S23, the flow proceeds to the process of S17.

When the return value of the after-move condition determination process of S22 is “false” (when the move management unit 37 determines that the first condition is not satisfied) (“NO” in S22), the move management unit 37 proceeds to the process of method 4 (S24).

FIG. 13 illustrates a flow of the after-move condition determination process in this embodiment. The after-move condition determination process is a process for determining whether a load value satisfies an ith condition (i=1,2) when it is assumed that a pattern matching process (load) corresponding to a distribution key value (x) of a selected event is moved from the move source detection server (src) to the move destination detection server (dst). Here, the load value is a value of Tproc when the move management unit 37 determines whether the first condition is satisfied, or is a value of Tcomm when the move management unit 37 determines whether the second condition is satisfied.

As input parameters, Tproc or Tcomm, the move source detection server (src), the move destination server candidate (dst), an event type, and the distribution key value (x) or the combination (z) are input.

The move management unit 37 determines whether a load value is smaller than the lower limit threshold value in the move source detection server (src) and whether the load value exceeds the upper limit threshold value in the move destination server candidate (dst) when it is assumed that the load is moved from the move source detection server (src) to the move destination detection server (dst) (S31). Here, when the distribution key value x is designated as an input parameter, the load is all patterns corresponding to the distribution key value (x) of the event. In the meantime, when z is designated as an input parameter, the load is a pattern (y) among the patterns corresponding to the distribution key value (x) of the event.

When the move management unit 37 determines that the load value is not smaller than the lower limit threshold value in the move source detection server (src) and the load value does not exceed the upper limit threshold value in the move destination server candidate (dst) (when the ith condition is satisfied: “YES” in S31), the move management unit 37 returns “true” as a return value to a process at a call source (S32). In the meantime, when the move management unit 37 determines that the load value is smaller than the lower limit threshold value in the move source detection server (src) or the load value exceeds the upper limit threshold value in the move destination server candidate (dst) (the ith condition is not satisfied: “NO” in S31), the move management unit 37 returns “false” as a return value to the process at the call source (S33).

FIG. 14 illustrates a flow of the load move process that uses method 2 and is executed by the move management unit of the management server in this embodiment. The flow of FIG. 14 represents details of the process of S6 illustrated in FIG. 8.

The move management unit 37 references the overall load table 38, and selects a detection server having a sum(Tcomm) that exceeds the upper limit threshold value or a detection server having the largest sum(Tcomm) as a move source detection server (src) (S41). The move management unit 37 issues a request to transmit content of the load table 45 to the selected move source detection server (src), and stores detailed load information obtained as a response in the detailed load table 39.

The move management unit 37 references the detailed load table 39, and selects a distribution key value (x) having the largest Tcomm among distribution key values of the event of the move source detection server (src) (S42).

The move management unit 37 references the overall load table 38, and selects a detection server having the smallest sum(Tcomm) as a move destination server candidate (dst) (S43). The move management unit 37 issues a request to transmit the content of the load table 45 to the selected move destination server candidate (dst), and stores detailed load information obtained as a response in the detailed load table 39.

The move management unit 37 executes the after-move condition determination process for determining whether the second condition is satisfied when it is assumed that the pattern matching process (load) corresponding to the distribution key value (x) of the event is moved from the move source detection server (src) to the move destination server candidate (dst) (S44).

As input parameters to the after-move condition determination process of S44, Tcomm (=coefficient k1×input frequency n), the move source detection server (src), the move destination server candidate (dst), an event type, and the distribution key value (x) are input. Details of the process of S44 are as described above with reference to FIG. 13.

When the return value of the after-move condition determination process of S44 is “true” (when the move management unit 37 determines that the second condition is satisfied) (“YES” in S45), the move management unit 37 executes the following process. Namely, the move management unit 37 issues a move instruction to the move source detection server (src) so that the process of all the patterns corresponding to the distribution key value (x) of the event that the move source detection server (src) is responsible for may be moved to the move destination server candidate (dst) (S46).

At this time, the move management unit 37 references a pattern list of the detailed load information, stored in the detailed load table 39, of the move destination detection server (dst), and determines whether the pattern names corresponding to the distribution key value (x) of the event to be moved are respectively included in the pattern list.

When all the pattern names corresponding to the distribution key value (x) of the event to be moved are included in the pattern list of the move destination detection server (dst), the move management unit 37 does not incorporate an instruction to transmit real data corresponding to the pattern names into the move instruction.

In the meantime, when a pattern name that is not included in the pattern list of the move destination detection server (dst) among the pattern names corresponding to the distribution key value (x) of the event to be moved is present, the move management unit 37 incorporates an instruction to transmit real data corresponding to the pattern name into the move instruction.

Upon receipt of the move instruction from the management server 36, the intermediate unit 43 of the move source detection server (src) transmits all the pattern names corresponding to the distribution key value (x) of the event to be moved to the move destination detection server (dst) on the basis of the move instruction. When the instruction to move the real data corresponding to the pattern names to be moved is also incorporated into the move instruction, the intermediate unit 43 also transmits the real data of the patterns.

After the combination of the distribution key value (x) of the event and the pattern is moved, the move source detection server (src) and the move destination detection server (dst) respectively update the load table 45. As a result, the load to be moved is moved from the move source detection server (src) to the move destination detection server (dst). Accordingly, the process using the moved combination of the event pattern, the distribution key value, and the pattern is executed not by the move source detection server (src) but by the move destination detection server (dst). Moreover, the move source detection server (src) and the move destination detection server (dst) respectively notify the management server 36 of load information (sum(Tcomm), sum(Tproc)) on the basis of the updated load table 45.

The move management unit 37 updates the overall load table 38 on the basis of the load information (sum(Tcomm), sum(Tproc)) received from the move source detection server (src) and the move destination detection server (dst).

The move management unit 37 determines whether the first and the second conditions are satisfied for both the move source detection server (src) and the move destination detection server (dst) (S47). Namely, the move management unit 37 references the overall load table 38, and determines, for both the move source detection server (src) and the move destination detection server (dst), whether sum(Tproc) falls within a range between the lower limit threshold value and the upper limit threshold value, and whether sum(Tcomm) falls within a range between the lower limit threshold value and the upper limit threshold value.

When neither the first condition nor the second condition is satisfied for the move source detection server (src) and the move destination detection server (dst) (“NO” in S47), the flow returns to S32. When the first and the second conditions are satisfied for both the move source detection server (src) and the move destination detection server (dst) (“YES” in S47), this flow is terminated.

When the return value of the after-move condition determination process is “false” (when the move management unit 37 determines that the second condition is not satisfied) (“NO” in S45), the move management unit 37 proceeds to the process of method 4 (S48).

FIG. 15 illustrates a flow of the load move process that uses method 3 and is executed by the move management unit of the management server in this embodiment. The flow of FIG. 15 represents details of the process of S9 illustrated in FIG. 8.

In FIG. 15, Tproc and Tcomm are generically referred to as a load value. For the sake of explanation, a case where a load value is Tproc is described in FIG. 15. However, Tcomm may be used as a load value.

The move management unit 37 issues a request to transmit content of the load table 45 to all the detection servers, and stores detailed load information obtained as a response in the detailed load table 39. The move management unit 37 references the detailed load table 39, and selects, as the move source detection server (src), a detection server that has a distribution key value (x) of the event having the smallest Tproc among all the detection servers (S51).

The move management unit 37 references the overall load table 38 and the detailed load table 39, and selects a detection server having the smallest sum(Tproc) other than the move source detection server (src) as the move destination detection server (dst) among the detection servers that possess the distribution key value (x) of the event (S52).

The move management unit 37 executes the after-move condition determination process for determining whether the ith condition is satisfied when it is assumed that a pattern matching process (load) corresponding to the distribution key value (x) of the event is moved from the move source detection server (src) to the move destination server candidate (dst) (S53). Here, i=1 when the load value is Tproc, or i=2 when the load value is Tcomm.

When the load value is Tproc, Tproc (=coefficient k2×input frequency n×the number of patterns corresponding to the distribution key value (x) of an event), the move source detection server (src), the move destination server candidate (dst), an event type, and the distribution key value (x) are input as input parameters to the after-move condition determination process of S53. When the load value is Tcomm, Tcomm (=coefficient k1×input frequency n), the move source detection server (src), the move destination server candidate (dst), the event type, and the distribution key value (x) are input as input parameters to the after-move condition determination process of S53. Details of the process of S53 are as described above with reference to FIG. 13.

When the return value of the after-move condition determination process of S53 is “true” (when the move management unit 37 determines that the ith condition is satisfied) (“YES” in S54), the move management unit 37 executes the following process. Namely, the move management unit 37 issues a move instruction to the move source detection server (src) so that the process of all the patterns corresponding to the distribution key value (x) of the event that the move source detection server (src) is responsible for may be moved to the move destination server candidate (dst) (S55).

At this time, the move management unit 37 references a pattern list of the detailed load information, stored in the detailed load table 39, of the move destination detection server (dst), and determines whether pattern names corresponding to the distribution key value (x) of the event to be moved are respectively included in the pattern list.

When all the pattern names corresponding to the distribution key value (x) of the event to be moved are included in the pattern list of the move destination detection server (dst), the move management unit 37 incorporates not the instruction to transmit the real data corresponding to the pattern names but the instruction to transmit the pattern names into the move instruction.

In the meantime, when a pattern name that is not included in the pattern list of the move destination detection server (dst) is present among the pattern names corresponding to the distribution key value (x) of the event to be moved, the move management unit 37 executes the following process. Namely, the move management unit 37 incorporates the instruction to transmit the pattern name and the instruction to transmit real data corresponding to the pattern name into the move instruction.

Upon receipt of the move instruction from the management server 36, the intermediate unit 43 of the move source detection server (src) transmits all the pattern names corresponding to the distribution key value (x) of the event to be moved to the move destination detection server (dst) on the basis of the move instruction. When the instruction to move the real data corresponding to the pattern names to be moved is also incorporated into the move instruction, the intermediate unit 43 also transmits the real data of the patterns.

After the combination of the event type, the distribution key value (x) and the pattern is moved, the move source detection server (src) and the move destination detection server (dst) respectively update the load table 45. In this way, the load to be moved is moved from the move source detection server (src) to the move destination detection server (dst). Accordingly, the process using the moved combination of the event type, the distribution key value, and the pattern is executed not by the move source detection server (src) but by the move destination detection server (dst). Moreover, the move source detection server (src) and the move destination detection server (dst) respectively notify the management server 36 of load information (sum(Tcomm), sum(Tproc)) on the basis of the updated load table 45.

The move management unit 37 updates the overall load table 38 on the basis of the load information (sum(Tcomm), sum(Tproc)) received from the move source detection server (src) and the move destination detection server (dst).

The move management unit 37 determines whether the system satisfies the third condition (S56). Namely, the move management unit 37 references the overall load table 38, and determines whether a total (total(sum(Tcomm)) of sum(Tcomm) of all the servers is equal to or smaller than the upper limit threshold value.

When the total (total(sum(Tcomm)) of sum(Tcomm) of all the servers exceeds the upper limit threshold value (when the third condition is not satisfied) (“NO” in S56), the flow returns to S51. When the total (total(sum(Tcomm) of sum(Tcomm) of all the servers is equal to or smaller than the upper limit threshold value (when the third condition is satisfied) (“YES” in S56), this flow is terminated.

When the return value of the after-move condition determination process of S53 is “false” (when the move management unit 37 determines that the ith condition is not satisfied (“NO” in S54), the move management unit 37 proceeds to the process of method 4 (S57).

FIG. 16 illustrates a flow of the load move process that uses method 4 and is executed by the move management unit of the management server in this embodiment. The flow of FIG. 6 illustrates details of the process of S10 illustrated in FIG. 8.

The move management unit 37 issues a request to transmit content of the load table 45 to all detection servers (src), and stores detailed load information obtained as a response in the detailed load table 39. The move management unit 37 determines whether any of the detection servers is smaller than the lower limit threshold value in the first condition or the second condition (S61). When the move management unit 37 determines that none of the detection servers is smaller than the lower limit threshold value in the first condition or the second condition (“NO” in S61), the move management unit 37 notifies a system administrator to add one detection server via electronic mail or the like (S62).

When the move management unit 37 determines that any of the detection servers is smaller than the lower limit threshold value in the first condition or the second condition (“YES” in S61), the move management unit 37 references the overall load table 38, and selects a detection server having a threshold value that is lower than the lower limit threshold value as the move source detection server (src) (S62).

The move management unit 37 references the detailed load table 39, and selects a detection server having the smallest Tproc other than the move source detection server (src) as the move destination detection server (dst) (S63).

The move management unit 37 selects one of the distribution key values (x) of the event that the move source detection server (src) is responsible for (S64).

The move management unit 37 executes the after-move condition determination process for determining whether the first condition is satisfied when it is assumed that a pattern matching process (load) corresponding to the distribution key value (x) of the event is moved from the move source detection server (src) to the move destination server candidate (dst) (S65).

As input parameters to the after-move condition determination process of S65T, Tcomm(=coefficient k1×input frequency n), the move source detection server (src), the move destination server candidate (dst), an event type, and the distribution key value (x) are input. Details of the process of S65 are as described above with reference to FIG. 13.

When the return value of the after-move condition determination process of S65 is “true” (when the move management unit 37 determines that the first condition is satisfied) (“YES” in S66), the move management unit 37 executes the following process. Namely, the move management unit 37 issues a move instruction to the move source detection server (src) so that the process of all the patterns corresponding to the distribution key value (x) of the event that the move source detection server (src) is responsible for may be moved to the move destination server candidate (dst) (S67).

At this time, the move management unit 37 references the pattern list, stored in the detailed load table 39, of the detailed load information of the move destination detection server (dst), and determines whether each pattern name corresponding to the distribution key value (x) of the event to be moved is included in the pattern list.

When all the pattern names corresponding to the distribution key value (x) of the event to be moved are included in the pattern list of the move destination detection server (dst), the move management unit 37 executes the following process. Namely, the move management unit 37 incorporates not an instruction to transmit real data corresponding to the pattern name but an instruction to transmit the pattern name into the move instruction.

In the meantime, when a pattern name that is not included in the pattern list of the move destination detection server (dst) among the pattern names corresponding to the distribution key value (x) of the event to be moved is present, the move management unit 37 executes the following process. Namely, the move management unit 37 incorporates an instruction to transmit the pattern name and an instruction to transmit the real data corresponding to the pattern name into the move instruction.

Upon receipt of the move instruction from the management server 36, the intermediate unit 43 of the move source detection server (src) transmits all the pattern names corresponding to the distribution key value (x) of the event to be moved to the move destination detection server (dst) on the basis of the move instruction. When the instruction to move the real data corresponding to the pattern name to be moved is also incorporated into the move instruction, the intermediate unit 43 also transmits the real data of the pattern.

After the combination of the event type, the distribution key value (x), and the pattern is moved, the move source detection server (src) and the move destination detection server (dst) respectively update the load table 45. In this way, the load to be moved is moved from the move source detection server (src) to the move destination detection server (dst). Accordingly, the process using the moved combination of the event type, the distribution key value, and the pattern is executed not by the move source detection server (src) but by the move destination detection server (dst). Moreover, the move source detection server (src) and the move destination detection server (dst) respectively notify the management server 36 of load information (sum(Tcomm), sum(Tproc)) on the basis of the updated load table 45.

The move management unit 37 updates the overall load table 38 on the basis of the load information (sum(Tcomm), sum(Tproc)) received from the move source detection server (src) and the move destination detection server (dst).

When the return value of the after-move condition determination process of S65 is “false” (when the move management unit 37 determines that the first condition is not satisfied) (“NO” in S66), the move management unit 37 executes the following process. Namely, the move management unit 37 selects a pattern (y) at random from among all the patterns of the event type that the move source detection server (src) is responsible for, and defines a combination of the pattern (y), the event type, and the distribution key value (x) as z (S69).

The move management unit 37 issues a move instruction to the move source detection server (src) so that the process (load) of the combination z of the selected pattern (y), the event type, and the distribution key value (x) may be moved to the move destination detection server (dst) (S70).

At this time, when the selected pattern name is already present in the move destination detection server (dst) in S69, the move management unit 37 does not incorporate the instruction to transmit the real data corresponding to the pattern name into the move instruction. In the meantime, when the selected pattern is not present in the move destination detection server (dst) in S69, the move management unit 37 incorporates the instruction to transmit the real data corresponding to the pattern name into the move instruction.

Upon receipt of the move instruction from the management server 36, the intermediate unit 43 of the move source detection server (src) transmits the pattern names corresponding to the distribution key value (x) of the event to be moved to the move destination detection server (dst) on the basis of the move instruction. When the instruction to move the real data corresponding to the pattern names to be moved is also incorporated into the move instruction, the intermediate unit 43 also transmits the real data of the patterns.

After the combination of the event type, the distribution key value (x), and the pattern is moved, the move source detection server (src) and the move destination detection server (dst) respectively update the load table 45. As a result, the load to be moved is moved from the move source detection server (src) to the move destination detection server (dst). Accordingly, the process using the moved combination of the event type, the distribution key value, and the pattern is executed not by the move source detection server (src) but by the move destination detection server (dst). Moreover, the move source detection server (src) and the move destination detection server (dst) respectively notify the management server 36 of load information (sum(Tcomm), sum(Tproc)) on the basis of the updated load table 45.

The move management unit 37 updates the overall load table 38 on the basis of the load information (sum(Tcomm), sum(Tproc)) received from the move source detection server (src) and the move destination detection server (dst).

After the process of S67 or S70, the move management unit 37 references the overall load table 38 or the detailed load table 39, and determines whether the move source detection server (src) possesses a process (S58).

When the move source detection server (src) possesses the process (“YES” in S68), the flow returns to S63. When the move source detection server (src) does not possess the process (“NO” in S68), the move management unit 37 issues, to a system administrator, a notification of deleting the move source detection server (src) from the system via electronic mail or the like (S71).

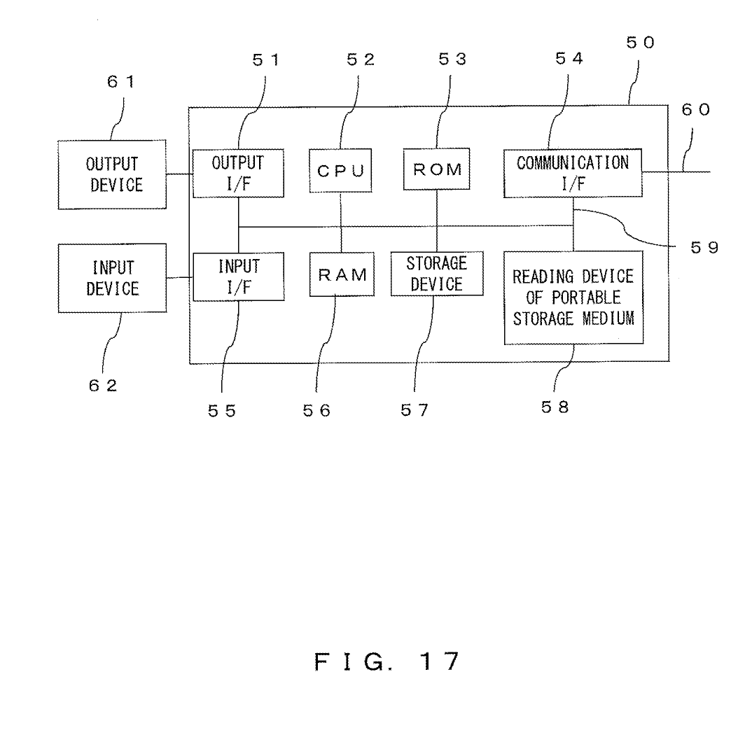

FIG. 17 illustrates an example of a configuration block diagram of a hardware environment of a computer that executes a program according to this embodiment. The computer 50 functions as the learning server 31, the transfer server 33, the management server 36, or the detection server 41. The computer 50 is configured by including a CPU 52, a ROM 53, a RAM 56, a communication I/F 54, a storage device 57, an output I/F 51, an input I/F 55, a reading device 58, a bus 59, an output device 61, and an input device 62.

Here, the CPU stands for a central processing unit. ROM stands for a read only memory. RAM stands for a random access memory. I/F stands for an interface. To the bus 59, the CPU 52, the ROM 53, the RAM 56, the communication I/F 54, the storage device 57, the output I/F 51, the input I/F 55, and the reading device 58 are connected. The reading device 58 is a device that reads a portable recording medium. The output device 61 is connected to the output I/F 51. The input device 62 is connected to the input I/F 55.

As the storage device 57, storage devices in various forms such as a hard disk, a flash memory, a magnetic disk, and the like are available. In the storage device 57 or the ROM 53, a program for causing the CPU 52 to function as the extraction unit 32, the transfer unit 34, the move management unit 37, or the detection unit 42 and the intermediate unit 43 is stored. Moreover, in the storage device 57 or the ROM 53, the routing table 35 is stored when the computer 50 is the transfer server 33. Additionally, in the storage device 57 or the ROM 53, the overall load table 38, the detailed load table 39, and the threshold value information 40 are stored when the computer 50 is the management server 36. Furthermore, in the storage device 57 or the ROM 53, the pattern table 44 and the load table 45 are stored when the computer 50 is the detection server 41. In the RAM 56, information is temporarily stored.

The CPU 52 reads and executes the program according to this embodiment.

The program that implements the processes referred to in the above described embodiment may be stored, for example, in the storage device 57 by being provided from a program provider side via a communication network 60 and the communication I/F 54. Alternatively, the program that implements the processes referred to in the above described embodiment may be stored in a portable recording medium that is marketed and distributed. In this case, the portable storage medium may be set in the reading device 58, and the CPU 52 may read and execute the program. As the portable storage medium, storage media in various forms, such as a CD-ROM, a flexible disk, an optical disk, a magneto-optical disk, an IC card, a USB memory device, and the like, are available. The program stored in such storage media is read by the reading device 58.

Additionally, as the input device 62, a keyboard, a mouse, an electronic camera, a Web camera, a microphone, a scanner, a sensor, a tablet, or the like is available. Moreover, as the output device 61, a display, a printer, a speaker, or the like is available. Additionally, the communication network 60 may be a communication network such as the Internet, a LAN, a dedicated line network, a wired network, a wireless network, or the like.

According to one aspect of the present invention, the leveling accuracy of a distributed load can be improved in a pattern detection distribution process of input data.

The present invention is not limited to the above described embodiment, and can take various configurations or embodiments within a scope that does not depart from the gist of the present invention.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program for causing a computer to execute a distribution process, the process comprising:
obtaining a load value relating to a detection process in units of pieces of identification information from each of a plurality of server devices that execute the detection process of a pattern for input data distributed by a transfer device that distributes the input data for each piece of the identification information in accordance with the identification information assigned to the input data; and
moving a combination of the identification information and one pattern corresponding to the identification information in units of combinations from a first server device to a second server device among the plurality of server devices depending on whether load values of the first server device and the second server device respectively fall within a specified allowable range, when the load value obtained from the first server device among the plurality of server devices exceeds the allowable range.

2. The non-transitory computer-readable recording medium according to claim 1, wherein
the moving issues, to the first server device, an instruction to move one or plurality of combinations to the second server device when a load value, obtained from the first server device, of a detected load of the first server device exceeds a first allowable range, and when the load values of detected loads of the first server device and the second server device respectively fall within the first allowable range after the one or the plurality of combinations are moved from the first server device to the second server device.

3. The non-transitory computer-readable recording medium according to claim 1, wherein
the moving further issues, to the first server device, an instruction to move the identification information and all patterns corresponding to the identification information to the second server device when a load value, obtained from the first server device, of a communication load of the first server device exceeds a second allowable range, and when the load values of communication loads of the first server device and the second server device respectively fall within the second allowable range after all patterns corresponding to the identification information processed by the first server device are moved from the first server device to the second server device.

4. The non-transitory computer-readable recording medium according to claim 1, wherein
the moving further issues, to the first server device, an instruction to move one or a plurality of combinations to the second server device when a total of load values, obtained from each of the plurality of server devices, of each of the plurality of server devices exceeds a third allowable range, and when the load values of detected loads of the first server device and the second server device respectively fall within the first allowable range following the pattern to be detected that is used in the detection process in which the load of the first server device that executes the detection process having the smallest load relating to the detection process is moved to the second server device.

5. The non-transitory computer-readable recording medium according to claim 1, wherein
the moving moves identification information of a pattern without moving real data of the pattern that is possessed by the second server device among patterns included in a combination to be moved, and moves real data of a pattern and identification information of the pattern that is not possessed by the second server device among patterns included in a combination to be moved.

6. The non-transitory computer-readable recording medium according to claim 1, wherein
the moving further issues a notification of adding or deleting the server device when the load values of the first server device and the second server device exceed the allowable range after the one or the plurality of combinations are moved to the second server device.

7. A distribution processing management apparatus comprising
a processor that executes a including:
obtaining a load value relating to a detection process in units of pieces of identification information from each of a plurality of server devices that execute the detection process of a pattern for input data distributed by a transfer device that distributes the input data for each piece of the identification information in accordance with the identification information assigned to the input data; and
moving a combination of the identification information and one pattern corresponding to the identification information in units of combinations from a first server device to a second server device among the plurality of server devices depending on whether load values of the first server device and the second server device respectively fall within a specified allowable range, when the load value obtained from the first server device among the plurality of server devices exceeds the allowable range.

8. The distribution processing management apparatus according to claim 7, wherein
the moving issues, to the first server device, an instruction to move one or a plurality of combinations to the second server device when a load value, obtained from the first server device, of a detected load of the first server device exceeds a first allowable range, and when the load values of detected loads of the first server device and the second server device respectively fall within the first allowable range after the one or the plurality of combinations are moved from the first server device to the second server device.

9. The distribution processing management apparatus according to claim 7, wherein
the moving further issues, to the first server device, an instruction to move the identification information and all patterns corresponding to the identification information to the second server device when a load value, obtained from the first server device, of a communication load of the first server device exceeds a second allowable range, and when the load values of communication loads of the first server device and the second server device respectively fall within the second allowable range after all the patterns corresponding to the identification information processed by the first server device are moved from the first server device to the second server device.

10. The distribution processing management apparatus according to claim 7, wherein
the moving further issues, to the first server device, an instruction to move one or a plurality of combinations to the second server device, when a total of load values, obtained from each of the plurality of server devices, of each of the plurality of server devices exceeds a third allowable range, and when the load values of detected loads of the first server device and the second server device respectively fall within the first allowable range after the pattern to be detected, which is used in the detection process in which the load of the first server device that executes the detection process having the smallest load relating to the detection process, is moved to the second server device.

11. The distribution processing management apparatus according to claim 7, the process further comprising
the moving moves identification information of a pattern without moving real data of the pattern that is possessed by the second server device among patterns included in a combination to be moved, and moves real data of a pattern and identification information of the pattern that is not possessed by the second server device among patterns included in a combination to be moved.

12. The distribution processing management apparatus according to claim 7, wherein
the moving further issues a notification of adding or deleting the server device when the load values of the first server device and the second server device exceed the allowable range after one or a plurality of combinations are moved to the second server device.

13. A distribution processing method comprising:
obtaining, by using a computer, a load value relating to a detection process in units of pieces of identification information from each of a plurality of server devices that execute the detection process of a pattern for input data distributed by a transfer device that distributes the input data for each piece of the identification information in accordance with the identification information assigned to the input data; and
moving, by using the computer, a combination of the identification information and one pattern corresponding to the identification information in units of combinations from a first server device to a second server device among the plurality of server devices depending on whether load values of the first server device and the second server device respectively fall within a specified allowable range, when the load value obtained from the first server device among the plurality of server devices exceeds the allowable range.

14. The distribution processing method according to claim 13, wherein
the moving issues, to the first server device, an instruction to move one or a plurality of combinations to the second server device when a load value, obtained from the first server device, of a detected load of the first server device exceeds a first allowable range, and when the load values of detected loads of the first server device and the second server device respectively fall within the first allowable range after the one or the plurality of combinations are moved from the first server device to the second server device.

15. The distribution processing method according to claim 13, wherein
the moving further issues, to the first server device, an instruction to move the identification information and all patterns corresponding to the identification information to the second server device, when a load value, obtained from the first server device, of a communication load of the first server device exceeds a second allowable range, and when the load values of communication loads of the first server device and the second server device respectively fall within the second allowable range after all the patterns corresponding to the identification information processed by the first server device are moved from the first server device to the second server device.
